(19) United States
(12) Patent Application Publication
(10) Pub. No.: US 2004/0126895 A1
(43) Pub. Date: Jul. 1, 2004

(54) DEPOSITING FLUID SPECIMENS ON SUBSTRATES, RESULTING ORDERED ARRAYS, TECHNIQUES FOR ANALYSIS OF DEPOSITED ARRAYS

(76) Inventors: JAMES W. OVERBECK, HINGHAM, MA (US); PETER T. FLOWERS, MILTON, MA (US); JEAN I. MONTAGU, BROOKLINE, MA (US); MYLES L. MACE SR., DOVER, MA (US); PETER HONKANEN, ARLINGTON, MA (US)

Correspondence Address: CHIEF INTELLECTUAL PATENT COUNSEL, AFFYMETRIX, INC., 3380 CENTRAL EXPRESSWAY, SANTA CLARA, CA, 95051, US

(21) Appl. No.: 09/079,324

(22) Filed: May 14, 1998

Related U.S. Application Data
(63) Continuation-in-part of application No. 09/006,344, filed on Jan. 13, 1998, now abandoned.
(63) Continuation-in-part of application No. 09/045,547, filed on Mar. 20, 1998, now Pat. No. 6,201,639.

(51) Int. Cl. G01N 1/10

(52) U.S. Cl. 436/180; 422/100

(57) ABSTRACT

Fluid is deposited in spots using supported, compliant pin arragements, supplied by a local reservoir. Pin arragements in the form of reciprocating and rotating devices are shown. Supply of the pins by mobile local subreservoirs limit the range of travel between drop-pickup and drop deposit. Local reservoirs in the form of circular rings and large pins are disclosed. Compliance is achieved by using spring and flexure arrangements. Some embodiments employ planer flexures to mount the pin and constrict its movement. Such deposit techniques are shown used in many analytical, reactive, and productive conditions. Combination of the use of the versatile, high density array or with a flying mini objective, wide field scanning microscope is disclosed. Combination with other sub systems adds to the versatility of the system.

### CROSS REFERENCE TO RELATED APPLICATIONS

This application is a continuation in part of U.S. patent application Ser. No. 09/006,344, filed Jan. 13, 1998, entitled “Depositing Fluid Specimens on Substrates”, of U.S. patent application Ser. No. 09/045,547, filed Mar. 20, 1998, entitled “Wide Field of View and High Speed Scanning Microscopy” and of U.S. patent application Ser. No. ______ [to be supplied], filed contemporaneously herewith, entitled “Focusing in Microscope Systems”, each of which is hereby incorporated by reference.

### BACKGROUND OF THE INVENTION

The invention relates to the deposit upon substrates of small quantities of fluid specimens in a precise manner and in arrays of desired density and consistency. The invention is useful, for instance, in carrying out reactions, in providing accurate overlays of deposits, and, in particular, in preparing microscope slides with biological materials.

The invention also relates to array products produced by the novel deposit techniques and to methods of analysis that employ the deposit techniques.

In the field of biochemistry, it is desirable to accurately and efficiently deposit tens, hundreds, thousands and tens of thousands of samples of differing compositions on reaction or examination areas. Improvement in the speed of deposition, the precision of the size, shape, quantity and location of the deposits and the control over density of the deposits can lead to important advantages in the production of reference materials for research and diagnosis, and in the cost, rate and accuracy of research and diagnostic activity.

In genome research, for instance, it is desirable to rapidly deposit as few as ten or as many as fifty thousand or more spots or dots of fluid sample within the examinable area of a single microscope slide of about 22×48 mm dimension. It is important to do this in such a manner that the dots are precisely formed, are not contaminated by the equipment or adjacent dots, and are in an ordered array suitable for examination by automated or semi-automated scanning or reading instruments that can relate particular observed results to particular specimens.

In many cases it is desired to produce inexpensively a given array on a number of identical microscope slides for use as reference or diagnostic aids.

Also, in biological and chemical research it is desired to combine one material with another for analytical purposes.

Known techniques are in many cases time-consuming or require complex equipment, and often require procedures or skill that limit their use. In particular, a way to deposit or combine RNA and DNA fragments or the reagents used with such fragments is desired that employs sufficiently low cost equipment and procedures that it is affordable to the laboratories of individual researchers.

### SUMMARY OF THE INVENTION

An apparatus according to one aspect of the invention is provided for deposit of fluid samples in an array of mutually isolated dots, comprising a deposit device, a fluid source for repeatedly providing a discrete drop of fluid on the deposit device, mechanism for moving the device relatively over an array of spaced apart deposit locations of a receiving substrate, mechanism for repeatedly moving the device, relatively, toward and away from the receiving substrate to deposit respective drops of fluid at respective deposit locations on the substrate by direct contact of drops of fluid on the deposit device with the substrate without direct contact of the deposit device with the substrate.

Preferably the local fluid storage device and the deposit device are coupled for transverse motion across the array, preferably, the local fluid storage device being the deposit device are decoupled for movement toward and away from the substrate. Also preferably, the local storage device is constructed and arranged to be replenished from a remotely located relatively large reservoir, preferably, the reservoir being constructed to store a multiplicity of isolated fluid volumes, the apparatus constructed to move the local supply device to a selected fluid volume of the reservoir for replenishment, and preferably the volumes comprise the wells of a plate and the local storage device is constructed to dip into the well, preferably, the local storage device a fluid retaining surface having a surface roughness of at least 1000 microinch. Preferably the local fluid storage device is constructed produce relative resupply movement between the deposit device and the local storage device for the deposit of each discrete fluid drop. Preferably, the deposit device is a moveable pin and the local storage device includes a member which defines a generally annular fluid retention surface, and the deposit pin is constructed to move within the annular retention surface from retracted to extended positions, in the retracted position the deposit end of the pin being retracted from the lower surface of fluid retained by the annular surface of the storage device, and in the extended position the deposit end of the pin being projected beyond the lower surface of the retained fluid. Preferably, in this case, includes a member which defines a generally annular fluid retention surface, and the deposit pin is constructed to move within the annular retention surface from retracted to extended positions, in the retracted position the deposit end of the pin being retracted from the lower surface of fluid retained by the annular surface of the storage device, and in the extended position the deposit end of the pin being projected beyond the lower surface of the retained fluid. Preferably in this case, the annular surface is generally aligned with the pin and a driver is associated with the member that defines the annular surface to move the member generally linearly downwardly beyond a position of a deposit end of the pin to a replenishment position, the pin and the member defining the annular surface and associated drivers being movable to the cleaning system, and to a replenishment region in which the annular member is replenished.

The deposit device is mounted on a flexure which constrains the device to a predetermined path of travel, and a driver is engaged to cause reciprocal motion constrained by the flexure, between retracted and extended positions depending upon the position of the driver.

A stable spring is arranged to urge the deposit device in the direction opposite to the deposit motion.

Preferred embodiments of this aspect of the invention employ one or more of the following features.

The deposit device is flexibly mounted and associated with a dampener that enables compliant, dampened contact of the device with the substrate via an intervening film of the fluid.

The deposit device is a moveable pin.

The fluid source includes a fluid storage device relative to which the deposit device repeatedly moves to resupply the device during the deposit of successive drops, preferably the fluid storage device being a local fluid storage device generally movable over the array of deposit locations, the fluid storage device being constructed and arranged to resupply the deposit device at various locations with respect to the array.

The flexure system is constructed to maintain substantially a constant angle between the deposit device and the substrate as the deposit device approaches the substrate, preferably the flexure system comprising a pair of parallel flexures, preferably the flexures being cantilered. Alternatively, the flexure system comprises a single flexure.

The deposit device is mounted on a multiple flexure system, preferably, a relatively stiff flexure supports the deposit device via an intermediate relatively compliant flexure, the driver for the device engaged, effectively, with the relatively stiff flexure, and the deposit device being free to deflect relative to the stiff flexure by action of the compliant flexure, upon encountering resistance when moving toward the substrate.

According to another aspect of the invention, an apparatus is provided for deposit of fluid samples in a dense array of mutually isolated dots, comprising a deposit pin, a fluid source for repeatedly providing a drop of fluid on the end of the deposit pin, mechanism for moving the pin relatively over an array of spaced apart deposit locations of a receiving substrate, mechanism for repeatedly moving the pin, relatively, toward and away from the receiving substrate to deposit respective drops at respective deposit locations on the substrate, and wherein the pin is mounted on a flexure system which constrains the pin to a predetermined path of travel, and a driver is engaged to drive the pin to enable reciprocal motion, constrained by the flexure system, between retracted and extended positions depending upon the position of the driver.

22. The apparatus of claim 21 in which the damping element is a damping layer laminated to a spring layer.

23. The apparatus of claim 22 comprising a lamination of a metal spring layer and a damping layer.

24. The apparatus of claim 22 in which the flexure includes a spring layer laminated on opposite sides of a damping layer.

25. The apparatus of claim 1 in which the deposit device is mounted on a multiple flexure system.

26. The apparatus of claim 25 in which at least one relatively stiff flexure supports the deposit device via at least one intermediate relatively compliant flexure, a driver engaged, effectively, with the relatively stiff flexure, and the deposit device being free to deflect by action of the compliant flexure, upon encountering resistance when moving toward the substrate.

27. The apparatus of claim 1 in which the deposit device is arranged to engage the substrate via a film of the fluid with a pressure less than about 1 gram.

28. The apparatus of claim 1 in which the deposit device has a natural frequency of at least 10 Hz.

29. The apparatus of claim 1 including a cleaning system, and a control system adapted to control relative movement of the deposit device to a depositing relationship to the substrate and a cleaning relationship to the cleaning system.

30. The apparatus of claim 29 in which the deposit device is associated with a local supply device that travels with it, the deposit device and local supply device movable together to the cleaning system.

31. An apparatus for deposit of fluid samples in a dense array of mutually isolated dots, comprising a deposit device, a fluid source for repeatedly providing fluid to the deposit device, mechanism for moving the device relatively over an array of spaced apart deposit locations of a receiving substrate, mechanism for repeatedly moving the deposit device, relatively, toward and away from the receiving substrate to deposit respective drops of fluid at respective deposit locations on the substrate, and a control system adapted to control relative movement of the deposit device to a deposit relationship with the substrate, wherein the deposit device is mounted on a flexure system which constrains the device to precise motion, and a driver is engaged to drive the deposit device to enable reciprocal motion, constrained by the flexure system, between retracted and extended positions depending upon the position of the driver.

32. The apparatus of claim 31 in which the flexure system is constructed to maintain substantially a constant angle between the deposit device and the substrate as the deposit device approaches the substrate.

33. The apparatus of claim 32 in which the flexure system comprises a pair of parallel flexures.

34. The apparatus of claim 33 in which the flexures are ______.

35. The apparatus of claim 32 in which the flexure system comprises a single flexure.

36. The apparatus of claim ______ in which the deposit device is mounted on a multiple flexure system.

37. The apparatus of claim 35 in which a relatively stiff flexure supports the deposit device via an intermediate relatively compliant flexure, the driver for the device engaged, effectively, with the relatively stiff flexure, and the deposit device being free to deflect relative to the stiff flexure by action of the compliant flexure, upon encountering resistance when moving toward the substrate.

38. An apparatus for deposit of fluid samples in a dense array of mutually isolated dots, comprising a deposit pin, a fluid source for repeatedly providing a drop of fluid on the end of the deposit pin, mechanism for moving the pin relatively over an array of spaced apart deposit locations of a receiving substrate, mechanism for repeatedly moving the pin, relatively, toward and away from the receiving substrate to deposit respective drops at respective deposit locations on the substrate, and wherein the pin is mounted on a flexure system which constrains the pin to a predetermined path of travel, and a driver is engaged to drive the pin to enable reciprocal motion, constrained by the flexure system, between retracted and extended positions depending upon the position of the driver.

36. An apparatus for deposit of fluid samples in a dense array of mutually isolated dots, comprising at least two deposit pins, at least one fluid source for repeatedly providing a drop of fluid on the end of each deposit pin, mechanism for moving the pins together transversely over an array of spaced apart deposit locations of a receiving substrate, mechanism for repeatedly moving each pin independently, relatively, toward and away from the receiving substrate to deposit respective drops at respective deposit locations on the substrate.

37. The apparatus of claim 36 constructed to mount a number of microscope slides to serve as said substrate in deposit-receiving relationship, and a control system constructed and arranged to move the deposit pins in the manner to form deposits on more than one slide.

36. The apparatus of claim 22 in which at least four such pins and drivers are mounted on a deposit head.

37. A deposit mechanism for deposit of biological fluid dots in an array, comprising a pin supported by a flexure, a source of biological fluid for deposit, and a driver engaged to drive the pin to enable reciprocal motion constrained, between retracted and extended positions depending upon the position of the driver.

38. The apparatus of claim 37 including a discrete local fluid supply for the pin.

39. The apparatus of claim 38 in which a member defines a generally annular fluid retention surface, and the deposit pin is constructed to move within the annular retention surface from retracted to extended positions, in the retracted position the deposit end of the pin being retracted from the lower surface of fluid retained by the annular surface of the storage device, and in the extended position the deposit end of the pin being projected beyond the lower surface of the retained fluid.

40. The apparatus of claim 39 in which a driver is arranged to move the annular member generally downwardly beyond the deposit end of the pin to a replenishment position.

41. The apparatus of claim 40 in which the flexure-mounted pin and the member defining on annular retention surface are associated with respective drivers.

42. The apparatus of claim 40 in which the pin and member are movable as an assembly to a station for cleaning, and to a replenishment region in which the member is replenished from a selected source.

43. The apparatus in which at least four pin and annular member assemblies according to claim 40 are clustered for movement together transversely over the substrate.

43. The apparatus in which two or more deposit pins according to claim 39 are grouped together for movement by a single drive as a corresponding member of members defining annular fluid retention surfaces according to claim 39 are associated respectively with respective pins, the members driven by a single drive member.

44. An apparatus for deposit of fluid samples in a dense array of mutually isolated dots, comprising a deposit device, a source of fluid for the deposit device, mechanism for moving the deposit device relatively over an array of spaced apart deposit locations of a receiving substrate, mechanism for repeatedly moving the deposit device, relatively toward and away from the receiving substrate to deposit respective drops of fluid at respective deposit locations on the substrate, a cleaning system, and a control system adapted to control relative movement of the deposit device between a resupply relationship to the source, a depositing relationship to the substrate and a cleaning relationship to the cleaning system.

45. The apparatus of claim 44 wherein the source includes a fluid storage device relative to which the deposit device repeatedly moves to resupply the device during the deposit of the isolated drops of fluid.

46. The apparatus of claim 45 in which the fluid storage device is a mobile local fluid storage device generally movable with the deposit device over the array of deposit locations, the fluid storage device being constructed and arranged to locally resupply the deposit device during its deposit sequence.

47. The apparatus of claim 46 in which the local storage device is constructed and arranged to be replenished from a remotely located relatively large reservoir.

48. The apparatus of claim 47 in which the reservoir is constructed to store a multiplicity of isolated fluid volumes, the apparatus constructed to move the local supply device to a selected fluid volume of said reservoir for replenishment.

49. The apparatus of claim 47 constructed to produce relative resupply movement between the deposit device and the local storage device for the deposit of each discrete drop.

40. The apparatus of claim 46 in which the local supply device is driven to enter a supply well and having a surface adapted to retain a supply of fluid by surface tension or capillar effects.

41. The apparatus of claim 40 in which a retaining surface of the local supply has surface roughness of at least 1000 microinch.

42. The apparatus of claim 41 in which a member has an inner annular surface having the surface roughness.

43. The apparatus of claim 44 in which the member has an outer surface that is by ______.

44. The apparatus of claim 41 sized and constructed to enter a well of a PCR plate and extract fluid by surface position or capillary efforts for supply to the deposit device.

45. Apparatus for automated preparation of a microscope slide, comprising a microscope slide holder, a carrier operative over a slide on the holder, and a deposition head mounted on the carrier, the deposition head including a deposit pin constructed to carry a drop of fluid from a fluid supply, and mechanism constructed, in a deposit sequence, to move the deposit pin relative to the supply to pick up a drop of fluid, and move the deposit pin toward the microscope slide to completely deposit the drop of fluid on the slide, there being a control system arranged to repeat the deposit sequence to produce a high density of drops of deposited fluid upon the slide.

46. The device of claim 45 in which the deposit pin has a deposit end comprising an abrupt profile that defines the perimeter of the drop of fluid to be picked up.

47. The device of claim 46 in which the pin comprises a generally cylindrical shaft and an end rim.

48. The deposition head of claim 47 in which the end rim is defined by a generally planar butt end of the pin.

49. The device of claim 45 wherein the supply comprises a sub-reservoir mounted on the head, closely adjacent to the deposit pin.

50. The device of claim 45 or 49 constructed to prepare a series of slides in identical manner, the carrier constructed to hold a series of slides, and the control system constructed to deposit a drop of a given composition upon identical locations on the series of slides, by respective movements of the head.

51. The device of claim 50 in which the deposition head comprises a multiplicity of said deposit pins ganged to form a multiplicity of drops.

52. The device of claim 50 in which the deposit pins are associated with respective discrete drivers.

53. The device of claim 51 in which the deposit pins are associated with a single driver.

54. The device of claim 45 wherein the deposition head comprises an annular supply ring constructed to be immersed in and withdrawn from a well of a sample-containing reservoir to retain between wall portions of the annular ring a supply of fluid carrying material to be examined, the deposit pin being operative within the annular ring to move generally axially between a retracted position in which a deposit end of the pin is withdrawn above an exposed surface of the retained sample, and an extended position in which a dot of the fluid is carried on the end of the pin for deposit on the slide.

55. The device of claim 45 or 54 in which the deposit pin is mounted on at least one flexure that constrains the deposit pin to a predetermined path of travel relative to the head.

56. Apparatus for deposit of fluid samples in a dense array of mutually isolated dots on a receiving surface comprising a deposit pin, a fluid source for repeatedly providing a drop of fluid on the end of the deposit pin, mechanism for moving the pin relatively over an array of spaced apart deposit locations of a receiving substrate, mechanism for repeatedly moving the pin, relatively, toward and away from a targeted point on the receiving substrate to deposit respective drops of fluid at respective deposit locations on the receiving surface, and means for stopping movement of the depositing pin toward the targeted point on the receiving surface while fluid remains between the end of the pin and the receiving surface.

57. The apparatus of claim 56 in which said means comprises a compliant system that limits the motion of the pin in response to resistance force transmitted to the pin.

58. The apparatus of claim 57 in which the resistance force is predetermined to be less than the total displacing force required to cause the pin to displace the fluid so much that the pin makes solid contact with the receiving surface.

59. The apparatus of claim 56 in which a spring system mounting the deposit pin limits the force with which the deposit pin presses toward the receiving surface.

60. The apparatus of claim 59 in which the deposit pin is coupled to the driver by a weak spring of selected spring value.

61. The apparatus of claim 60 in which the strength of the spring is selected to enable the deposit pin to cease movement toward the receiving surface before termination of movement of the driver.

62. The apparatus of claim 54 or 45 in which over-travel of the driver of the pin toward the receiving surface is permitted by the weak spring without significant effect upon the spacing of the end of the pin from the receiving surface.

63. The apparatus of claim 57 in which the compliant system including a leaf spring or flexure.

64. The apparatus of claim 60 in which the weak spring is supported on a relatively stiff spring engaged by the driver for moving the deposit pin.

65. An apparatus comprising a deposit pin constructed and arranged to deposit a first dot upon a substrate and thereafter, in registration, to deposit a second dot upon the first dot.

66. The apparatus of claim 65 in combination with a source of multiple fluids comprising a first fluid for said first dot and a second fluid for the second dot, the first and second fluids selected to potentially interact.

67. The apparatus of claim 65 including a device for depositing a large spot of a given reagent and a device for depositing dots of smaller size of different reagents upon the deposited large dot.

68. A fluid deposit arranger for transferring a drop of fluid to a substrate by engaging the drop with the substrate, the device mounted on a compliant spring for compliant engagement with the substrate and incorporating a motion damping member.

69. The fluid deposit arranger of claim 68 in which the spring comprises a flexure mounting.

70. The arranger of claim 69 in which at least one portion of the flexure mounting comprises a composite in which a layer of flexible damping material is bonded to a flexure member.

71. The arranger of claim 70 in which a pair of flexure members are bonded together in a composite sandwich containing a layer of damping material.

72. The arranger of claim 70 in which the flexible damping layer comprises a rubber or rubber-like compound.

73. The arrayer according to claim 71 in which at least one of the flexure layers of the composite is a resilient plastic layer.

74. The arrayer according to claim 73 in which at least one of the flexure layers comprise polyamide.

75. The arrayer according to claim 71 in which one of the flexure layers comprises a spring metal and the other layer comprises a bonding material having damping characteristics.

76. The arrayer according claim 69 in which the flexure is a planar flexure about 8 mm in width and between about 20 and 25 mm in length.

77. The arrayer according to claim 71 in which a layer of flexible resin is laminated by rubber cement to a flexible metal layer.

78. The arrayer of claim 68 in which a deposit pin is mounted upon a pair of parallel flexures.

79. The array of claim 78 in which at least one of the flexures comprises spring metal, and the other comprises, at least in part, a material having greater dampening properties than said spring metal.

80. The arrayer of claim 78 in which both parallel flexures comprise a sandwich according to claim 77.

81. The arrayer of claim 68 having a natural frequency greater than about 10 HZ.

82. A deposit head including at least two flexure mounted pins, and a single actuator arranged to move the pins simultaneously from supply to deposit positions, the head mounted for lateral movement in both X and Y axes.

83. The deposit head of 82 in which the pins are spaced apart 9 mm.

84. A deposit head including at least two flexure mounted pins, each associated with its own actuator to be moved independently from supply to deposit position, the head mounted for lateral movement in both X and Y axes.

85. The deposit head of claim 84 in which the pins are spaced apart 9 mm.

86. An aliquot carrier defining a fluid-retaining aperture through which a deposit device can transit to pick up a drop of fluid to be deposited, internal surfaces defining said aperture having a surface roughness that increases its wettability.

87. The carrier of claim 86 in which the surface roughness is produced by a technique selected from the class of sanding, broaching, machining, screw or knurl forming, coating or forming the surface of particles that provide surface roughness as by sintering or molding.

87. The carrier of claim 86 in which the surface roughness is at least 100 microinch.

88. A process of printing comprising, under computer control, moving at least one flexure mounted pin to selected X,Y positions, and depositing with said pin, a desired material.

89. The method of claim 88 in which the material is an ink or dye.

90. The method of claim 89 in which the material is a photoresist material.

91. The method of claim 88 in which the material is a varnish or encapsulant.

92. A method of causing a biological compound to interact with another substance at a predetermined position on a substrate the step comprising depositing at least one of the compound or reagent in a precisely determined localized spot relative to the substrate by mechanically lowering a compliant pin, to which a drop of the compound or reagent is adhered by surface tension, toward the substrate until the drop contacts the substrate or a pre-applied compound on the substrate with the pin executing a controlled force of less than a gram thereon, and thereafter mechanically lifting the pin away from the substrate under conditions in which the fluid drop transfers to the substrate or the pre-applied compound on the substrate.

93. The method of claim 92 in which drops of both the compound and the other substance are successively deposited by the technique of claim 92.

94. The method of claim 92 in which the pin, when approaching the substrate, applies a force to the substrate with a force of abouth 0.5 grams.

95. The method of claim 92 in which the compliant pin is mounted upon a support by flexures that constrain the pin to substantially linear motion relative to the support, and moving the support carrying the flexures and pin toward the substrate in an overtraveling linear motion parallel to the direction to which the pin is constrained to deflect, during which motion the pin engages the substrate or pre-applied compound on the substrate, and the flexures deflect in response to resistance encountered by the pin, thereby cushioning the contact of the pin.

96. The method of claim 92 in which a supply of the biological compound or substance to be deposited by the pin is supported above the substrate at the deposit location within a ring by surface tension, and the pin is lowered through the ring in the manner that a relatively small drop of the reagent from the supply is adhered to the end of the pin by surface tension.

97. The method of claim 92 in which the fluid to be deposited from fluid selected the group of fluids described in the specification.

98. The method of depositing a biological fluid with a pin comprising supporting fluid within a ring by surface tension, and the pin is lowered through the ring in the manner that a relatively small drop of the reagent from the supply is adhered to the end of the pin by surface tension.

### BRIEF DESCRIPTION OF THE DRAWINGS

In the Figures:

FIGS. 1A-1E depict the action of a pin depositing, with light contact force, biological fluid or reagent on a precisely located, isolated position on a receiving surface such as a microscope slide.

FIG. 1F is a perspective of a deposit pin mounted by a pair of parallel spring flexures and acting through a mobile sub-reservoir that travels transversely with the pin.

FIG. 1G is a representation of a spring-mounted and damped deposit pin.

FIGS. 1H and 1I are partial cross-sectional views of alternate pin mounting constructions in which pairs of spring flexures cooperate to provide both spring mounting and damping of the motion of a deposit pin.

FIG. 2 depicts a mobile sub-reservoir that travels transversely with a deposit device, illustrated as a deposit pin.

FIG. 3 depicts a system employing the action depicted in FIG. 2, combined with a cleaning station and central supply of fluid specimen.

FIG. 4 is a side view and FIG. 5 a top view of a deposit head, comprising a deposit pin and an annular sub-reservoir, through which the deposit pin operates, while FIGS. 4A-4D depict a sequence of stages of the deposit action of the head of FIG. 4.

FIG. 4E depicts supply or resupply of the sub-reservoir of FIG. 4.

FIG. 4F depicts cleaning the ring and pin of FIG. 4 at a cleaning station and FIG. 4G depicts drying the pin and ring.

FIG. 4H depicts the narrow walls of the wells of a PCR plate and the supply of a subreservoir by immersion in a well.

FIG. 4I is a cross-sectional view of a presently preferred annular sub-reservoir device suitable for picking up low viscosity fluids from such a narrow main supply as illustrated in FIG. 4H, while FIG. 4J is an end view of the device of FIG. 4I.

FIG. 4K is a view similar to FIG. 4H of depositing dots of fluid on flat-bottomed wells of a conventional supply plate.

FIGS. 6 and 6A are perspective views of a combined weak and strong flexure mounting of a deposit pin at different stages during operation.

FIG. 6B is a perspective view of the subassembly of FIG. 6 combined with drivers for the pin and the sub-reservoir supply ring, while FIG. 6C is a side view of a similar system that includes return spring features.

FIGS. 6D and 6F are views similar to FIG. 6 of alternative embodiments, while FIG. 6E shows the flexure of FIG. 6D in the course of its manufacture.

FIG. 6G depicts an alternative mounting of a pin and sub-reservoir ring.

FIG. 7 shows a ganged deposit system having four independently operable deposit pins.

FIG. 7A is a partial perspective view and FIG. 7B is a plan view of a ganged deposit system having a number of deposit pins driven by a single driver and a corresponding number of sub-reservoir rings driven by a single driver; FIG. 7C is a perspective view of the ganged system driven by a linear stage.

FIGS. 8, 9 and 10 depict mechanism for implementing the system of FIG. 6G.

FIG. 11 is a perspective view of a machine for depositing dots of biological fluid in dense array upon a series of microscope slides.

FIGS. 12 and 13 show features of the control system, software and method for conducting the deposit action.

FIGS. 14 and 15 illustrate alternative single drop deposit devices.

FIG. 16 illustrates a recovery system in which unused fluid is returned to the respective well.

FIGS. 17A-D illustrate the process of depositing one deposit upon another in a precisely aligned manner while

FIGS. 18A-D illustrate deposit of a large spot upon which reactions occur with small spots.

FIGS. 19A-D illustrate multiple deposits formed by vertically upward deposit motions.

### DESCRIPTION OF EMBODIMENTS

A. Deposit Techniques

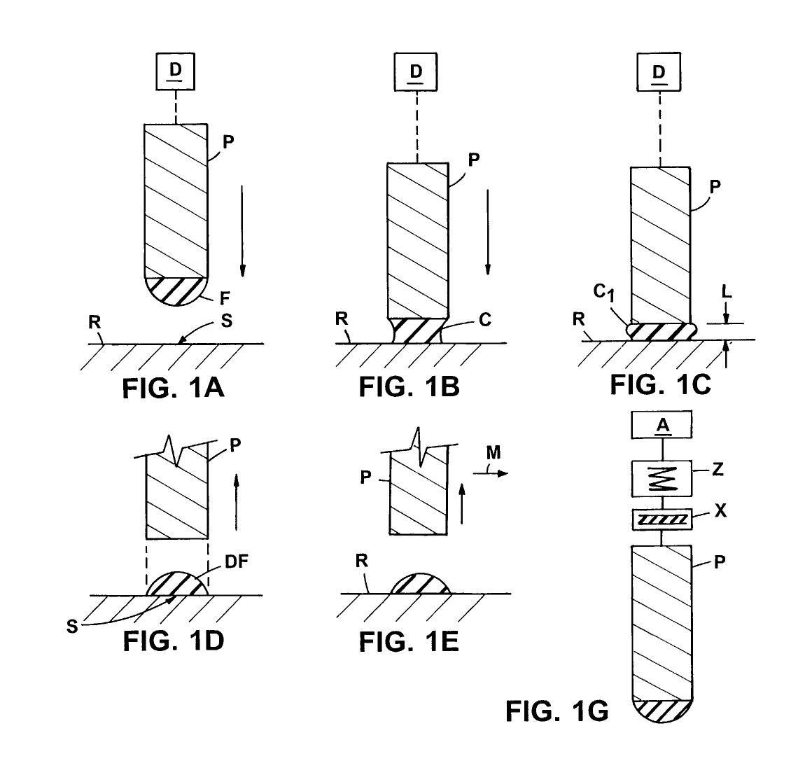

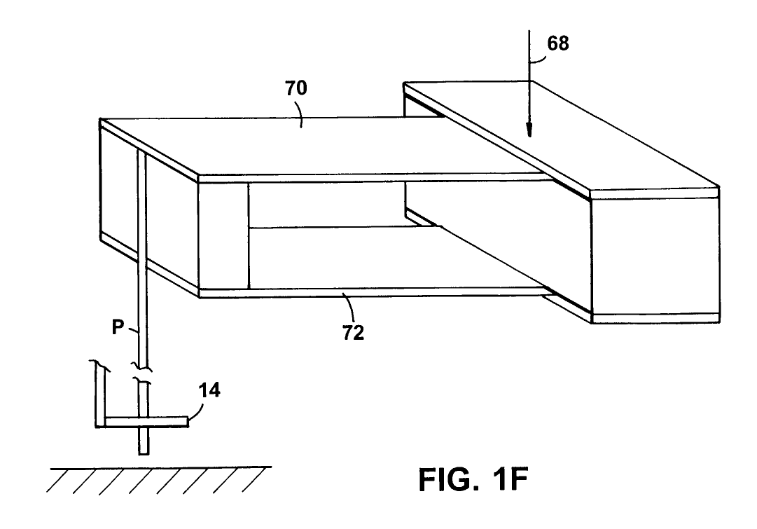

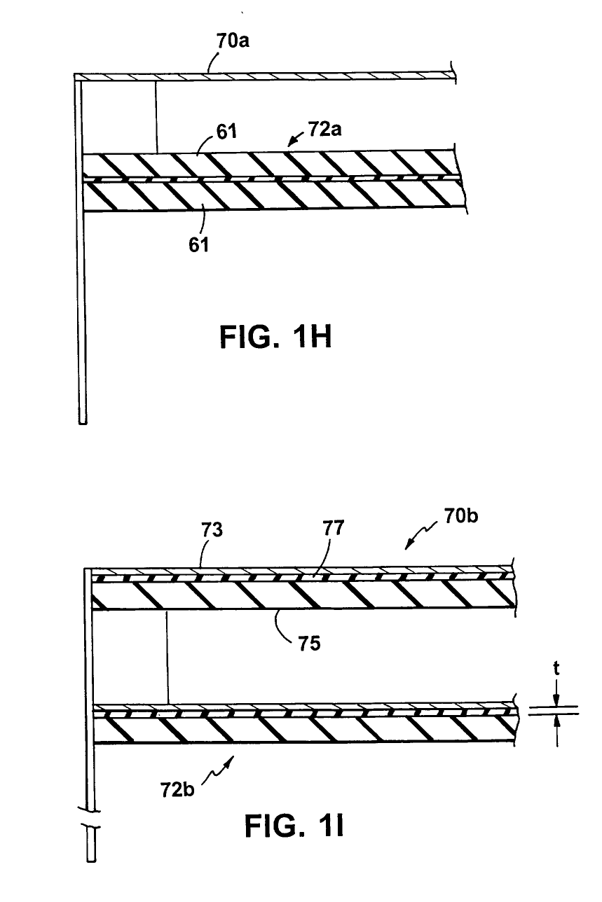

The general action of a deposit pin in respect of biological fluid or reagent is illustrated in the sequence of highly magnified FIGS. 1A-D.

In FIG. 1A, the deposit pin P is seen supporting a drop F of fluid specimen or reagent on its lower end, and moving under control of driver D toward a selected target point S on the receiving surface R. Surface R, when in the form of a microscope slide, is typically an impermeable non-wettable surface such as a silene-coated glass plate. Surface tension effects hold fluid drop F in substantially semi-spherical form on the end of the pin.

In FIG. 1B, the pin has advanced sufficiently toward the receiving surface R that contact of the drop with the surface has occurred. The drop has been forced to distort to a generally cylindrical shape, C.

In FIG. 1C, the pin P has advanced further toward surface R to approximately the desired limit of travel, L. The fluid cylinder C₁ is of expanded form, in which its boundary has been stretched, but it remains as a fluid cushion between the receiving surface and the tip of deposit pin P. At this stage, a control system for the driver D of the pin prevents further substantial movement of the pin toward the receiving surface R, so that the maximum force exerted by the pin upon the substrate is limited.

In a control system based upon position detection, the driver is stopped in response to the position sensor near level, while in hybrid systems, combinations of position and mechanical control systems can be employed, in manner apparent to those skilled in control technology in light of the present disclosure.

In the preferred case of a mechanical control system, a weak (i.e. highly compliant) spring of the drive train, in response to increasing resistance applied via the fluid now on the substrate, deflects dependently with advance of the driver, to limit or restrict further travel of the pin to near level L despite a degree of overtravel movement of the driver in the direction of the receiving surface.

In FIG. 1C the base of cylinder C₁, is shown expanded relative to the base of cylinder C in FIG. 1B. The degree of such expansion and the curvature of the wall of the cylinder is determined by the degree of wettability of the surface R and the surface tension characteristics of the selected fluid, as well as by the force applied.

In FIG. 1D, the pin P has moved away from surface R, leaving the drop F at the predetermined target point S on the receiving surface.

The drop is depicted as having contracted in base diameter. The degree of contraction or expansion is determined by the wettability of the receiving surface and the surface tension characteristics of the fluid. In the case of hydrophobic surfaces R, the deposited drop of fluid may contract as it dries, while in the case of relatively wettable surfaces, it may expand.

In FIG. 1E the pin P, devoid of fluid, is depicted as having continued to move away from receiving surface R, but also to have a component M of lateral movement, as it rapidly proceeds to the next target point. The pin P is thereafter resupplied with a new fluid drop, preferably from a local sub-reservoir, and the cycle is repeated.

Provision of a high compliance characteristic in the drive of the deposit pin enables a low and predictable contact force (a “soft landing”) to occur despite variations in the height of the receiving substrate, e.g., variations in the thickness of microscope slides upon which arrays of fluid dots are being applied. In using deposit pins, superior results can be obtained by controlling the force exerted by the deposit pin upon the substrate to less than the order of one gram, preferably about 0.5 grams (a force typically less than the weight of the pin itself, when stainless steel deposit pins are employed.) Over a suitable range of pin sizes, the pressure upon the fluid film is insufficient to disrupt the film and force it to spread significantly.

Long term dimensional stability of the depositing system over time, as temperature and other changes occur, is another desirable feature of the pin head assembly. It is desirable that the system enable spotting of, e.g., a full set of 40 microscope slides with 10,000 spots per slide. The process may require 2 days to 2 weeks, with the instrument operating unattended for many hours at a time. Use of a metal spring for the support of the deposit pin is preferably employed to achieve the desired stability.

For high speed operation, the compliant system also preferably has a natural resonant frequency higher than 10 Hz, e.g., 20 Hz, achieved by employing a low mass pin and clamp supported by a suitably compliant support.

In preferred embodiments employing cylindrical deposit pins moving axially normal to the deposit surface, it is observed that a spring support system for a pin with spring stiffness of less than 5 gram per millimeter deflection, measured at the pin, produces good results in cases in which the amount of pin deflection is a few tenths of a millimeter. In one particular case, a spring system having a spring deflection rate of 3 gram/mm, deflected about 0.2 mm, resulting in deposition of dots of fluid of excellent, repeatable quality over a range of microscope slides, the force exerted by the pin toward the surface being about 0.6 grams.

For achieving these various features and the avoidance of shedding particulates or fluid that may contaminate the experiment, flexure support of the deposit pin is preferably employed.

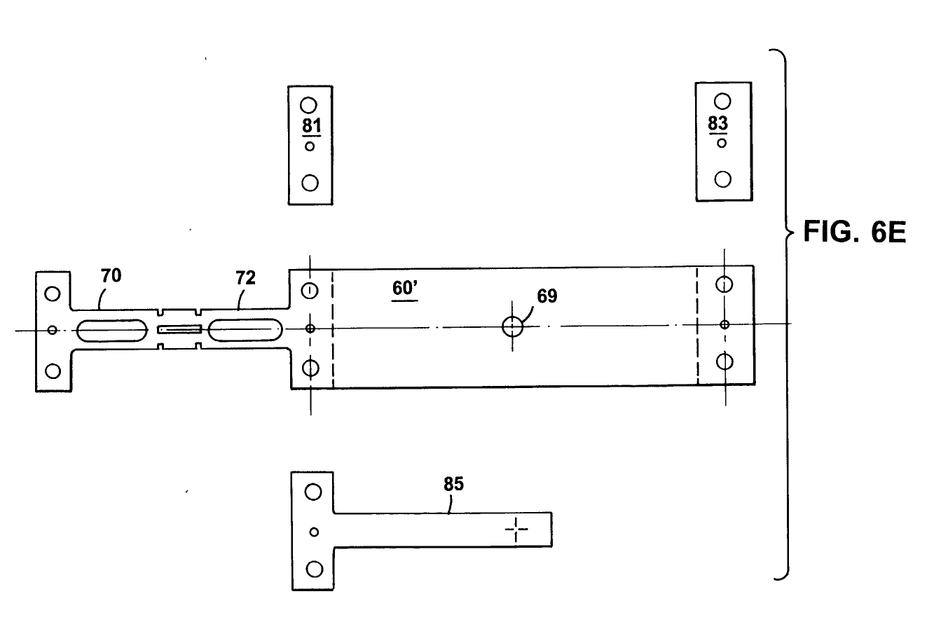

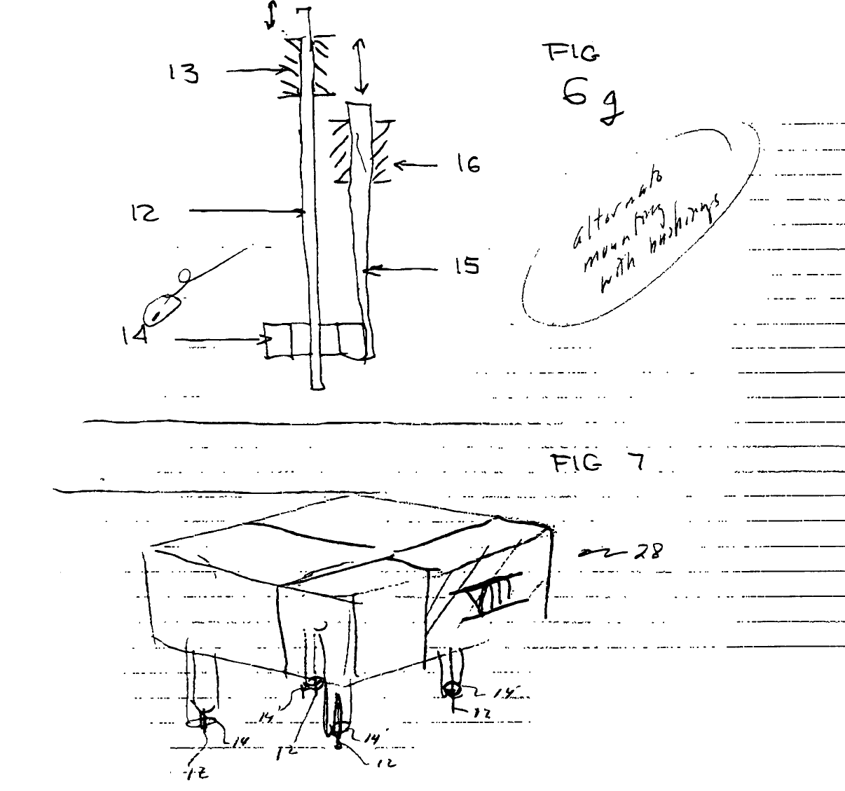

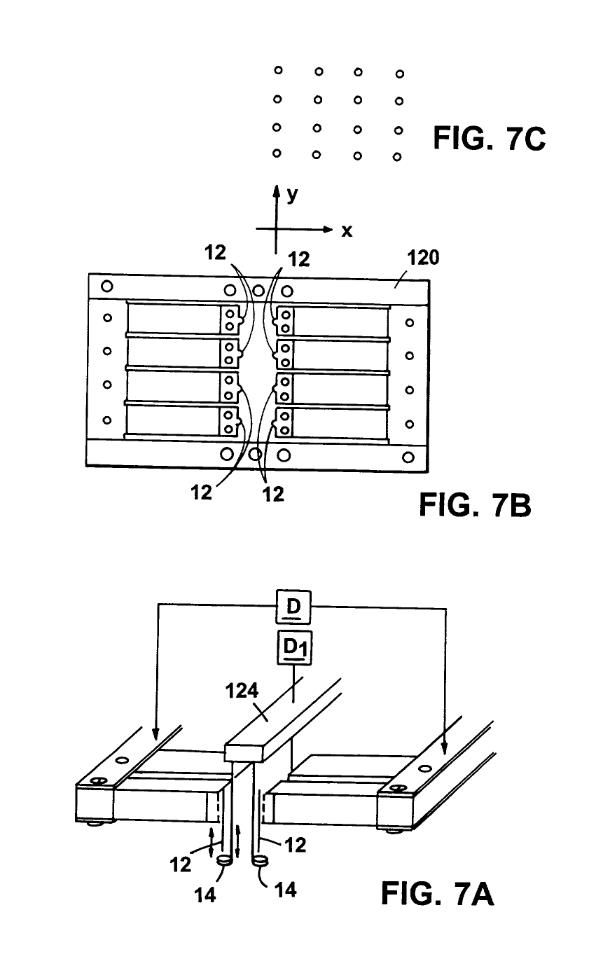

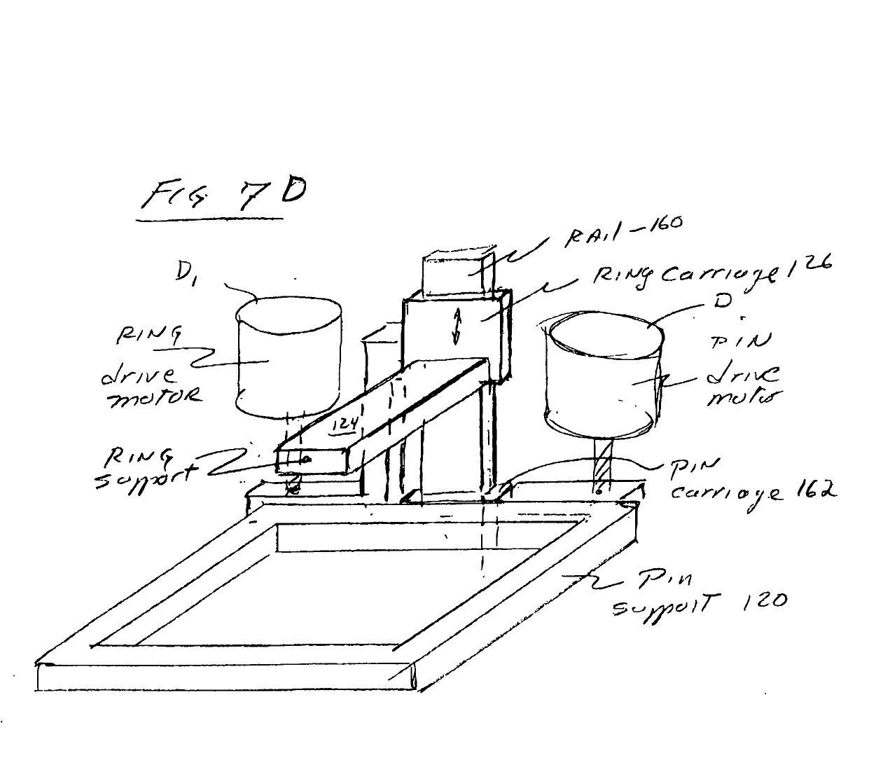

A suitable arrangement is shown in FIG. 1F, which employs a pair of parallel, planar, cantilevered flexures. Similar constructions are shown in FIGS. 6 and 6A and FIGS. 7A and 7B.

Deposit pin 12 mounted on spaced apart, parallel planar flexures 70, 72, that extend perpendicular to the direction of compliant motion of the pin. Thus a softened landing of the deposit pin occurs at a precise spot location upon the receiving substrate, by the positional constraint provided by the flexures. This ensures positional accuracy of the deposited dots of fluid and avoids problems over a wide range of conditions, including the presence of high humidity.

Positional accuracy and stability over the long term, sufficient to deposit precise arrays of small spots, e.g. of 50 micron (0.002 inch) diameter, is obtained by employing an element of spring metal in at least one of the flexures 70, 72 that ensures that the deposit pin returns to its original position after deposit of each drop.

To operate at high speed, e.g., to perform a drop formation-drop deposit cycle in 0.1 second, the pin mounting system, in addition to having a natural frequency greater than 10 Hz, has a provision for damping the motion of the moving pin element, preferably by an amount close to critical damping. This damping prevents the pin from bouncing and degrading the spotting process and enables the pin to be moved quickly away after each deposit action. In preferred embodiments, damping is obtained concurrently with providing very high compliance of the pin support. The general principle of combined compliance and damping is illustrated in FIG. 1G. The actuator A acts through a highly compliant support spring Z, buffered by a damping device X, the moving assembly having a natural frequency in excess of 10 Hz. Preferably, the pin bears with a maximum force of less than about 1.0 gram against the substrate, about 0.5 grams being presently preferred.

The features discussed, i.e. compliance, stability and damping and high natural frequency, are preferably achieved by flexure mounts now to be described.

Referring to FIG. 1H, two similar and highly compliant planar flexures 70a, 72a have similar elasticity, but one of them, flexure 70a, is made of a highly stable material, e.g. metal spring, and the other flexure, 72a, provides good damping properties.

The stable flexure 70a is preferably manufactured by photo etching a thin metal sheet, such as 0.002-inch thick stainless steel, which exhibits high stability and low rigidity but has poor damping properties. The other flexure 72a, preferably equally compliant, is provided with desired damping properties, and is less stable. The second flexure 72a, for instance, is constructed as a bonded sandwich of two identical photo-etched thin plastic sheets 61 such as 0.005 inch thick Kapton®, a polyamide resin, from duPont. An energy absorbent bonding agent, e.g., of thickness T of 0.002″ provides a damping layer between these resin sheets. The bonding agent may be a thin coat of rubber cement such as 3M part ID # 62-60065-4826-1 or 3M double sided tape # 927.

In a cluster of deposit pin assemblies, with 9 mm spacing, to correspond with the spacing of wells in a 96 well plate, the flexure elements are preferably 8 mm wide and 22 mm in length, and two or more of the pin and flexure assemblies are mounted in parallel, side by side, at 9 mm pin spacings. (Preferably two sets of such assemblies, disposed head-to-head as shown in FIGS. 7a, 7b are employed at 9 mm pin to pin spacings, so that an X, Y array of pins is achieved.)

In an alternate preferred construction shown in FIG. 1I, both flexures 70b, 72b are identical, each being a sandwich of one metal layer 73 and one resin layer 75 bonded together by rubber damping layer 77. Compliance similar to that of FIG. 1H is achievable either with the selection of material of appropriate thickness, such as a stainless steel layer 0.0016 inch thick or a copper-beryllium layer 0.0022 inch thick, bonded by the damping layer to a polyamide layer 0.005 inch thick.

The physical properties of the flexures can also be tailored to the particular need by change in geometry of the flexures. An example is the provision of cutouts shown in the embodiments of FIGS. 6-6B, 6D and 6E.

For construction, a large-area bonded sandwich may be fabricated of all three materials and the shape of flexures can then be produced by photo etching the desired outline and any cutouts.

### B. Fluid Supply Techniques and Interaction with Deposit Pins

For making a succession of deposits of the same fluid, as when preparing a number of microscope slides, a mobile sub-reservoir, supplied from a stationary central supply, travels with the deposit pin or other deposit device to a series of deposit locations.

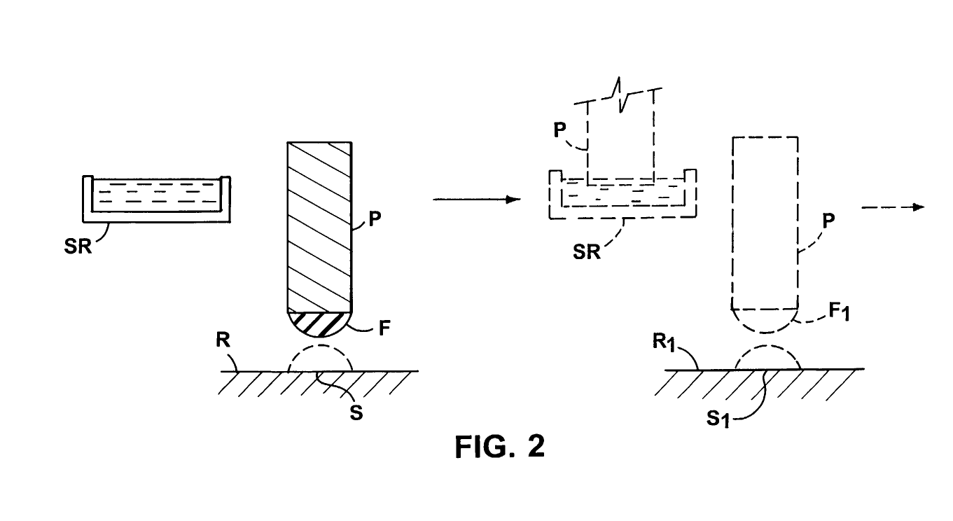

As illustrated in FIG. 2, a deposit head is shown comprising the deposit pin P of FIG. 1, and the sub-reservoir SR which is sized to contain sufficient sample to enable deposit of a number of dots before being resupplied.

After deposit of drop F at target S on microscope plate R, the assembly proceeds to plate R₁, pin P is resupplied with drop F₁ from the accompanying subreservoir SR, the new drop is then deposited at target point S₁, at plate R₁, and so on.

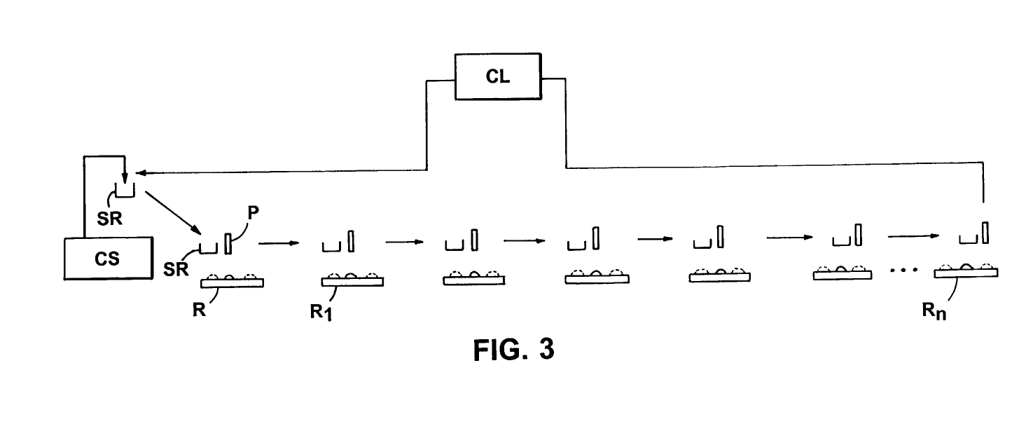

The system is especially useful for preparing a number of microscope slides as illustrated in FIG. 3. The central supply CS advantageously is a multiple well plate of a conventional size used in microbiology, such as a 96 well plate. Cleaning and drying stations CL are also provided. The deposit sequence includes moving the assembly of deposit device and mobile sub-reservoir through cleaning and drying stations CL, thence to central supply CS at which the sub-reservoir SR is supplied with a selected fluid sample, e.g. from a selected well in a 96 well plate, under computer control. Thence the grouping moves over a series of receiving surfaces R-Rₙ, for deposit of fluid dots at selected locations on each, also under computer control. This sequence is repeated a number of times, with controlled selection of different fluid samples (from, e.g., the same or different wells of the central supply CS) for respectively different locations on the microscope slides R or other receiving surfaces. Correlation data of respective locations with respective specimens is recorded and used in performing subsequent scanning or reading so that an observed result can be correlated to a given specimen.

The technique of using a deposit tool that accurately sizes each individual drop, such as the deposit pin illustrated, combined with a mobile local sub-reservoir that accompanies the tool and carries a volume sufficient to supply a sequence of deposits, has a number of important advantages. The technique, based on small motions, saves time in avoiding repeated travel to a central supply; it avoids evaporation effects of long travel, so that the drop created can be very small and the deposited array very dense; and the dots can be kept consistent in size and biological content across the array of dots being deposited. The time overhead involved in cleaning, transporting and picking up the specimen is kept small so that, overall, deposits can be made very fast and inexpensively.

In this way a large number (for instance ten to one hundred) identical microscope slides can readily be prepared. Each slide can carry dots of many different fluids based upon resupply of the sub-reservoir from different selected wells of a number of multiple well supply plates that are introduced to the system.

The sub-reservoir and the deposition device are decoupled, movable relatively to one another for resupply and deposit, as well as being coupled to move together laterally over the surface(s) to produce the series of deposits. The sub-reservoir can move into a resupply position, e.g. by immersion into a well, or under a suitable pipette. It can be made to hold sufficient fluid in excess of that required for the sequence of deposited dots so that the concentration of the substance of interest in the fluid is not substantially affected by evaporation from the sub-reservoir over the multiple deposit sequence.

The deposit device is constructed to have the ability to precisely obtain a single dot of desired size from the local sub-reservoir, deposit it at a precisely positioned, discrete location and return by local movement to the sub-reservoir for another drop.

A probe that dips into a local sub-reservoir as by coordinated rotational or translational motions of a wire or pin can accomplish this action, as can other designs.

However, in the preferred embodiment, an axially reciprocable deposit pin, as illustrated in FIG. 1, is employed in conjunction with an accompanying sub-reservoir. The pin is sized to only retain on its end enough material to deposit a single dot. This amount is defined by the diameter, shape and surface characteristics of the pin as well as by the viscosity or surface tension of the selected fluid to be deposited. Depending upon the size of the dot desired, the pin preferably comprises a wire having a diameter between about 0.002 inch and 0.010 inch, the pin having smooth side surfaces so that the drop is confined to the end of the pin.

For proper sizing of the dot from the sub-reservoir, the wire or pin has a sharply defined rim; presently we prefer the wire being square bottomed, with a right angle corner in profile.

In practical arrays of deposited dots the present desire is to have dots of diameter between about 20 microns to 200 microns, as deposited. Most such arrays can be formed with biological fluids of conventional concentration carried by the mobile sub-reservoir, with deposit pins of diameter between about 0.002 inch (50 microns) and 0.010 inch (250 microns) according to the present techniques.

By use of a large supply of the same wire in the manufacture of many units, standard pin dimensions can be assured from unit to unit, which enables comparison of results between various laboratories that have the units. In preferred cases, as mentioned above, the engaging action of such a pin against the receiving surface is controlled, preferably by a compliant mounting, with a maximum force preferably less than 1 gram, e.g. 0.5 gram, such that the surface layer is not ruptured and surface tension limits the squeezing out of fluid from between the pin and the receiving surface. In addition to ensuring that the deposited drop is well defined and precisely located, this protects the predetermined end geometry of the pin to preserve its accurate drop-sizing function over a long period of use.

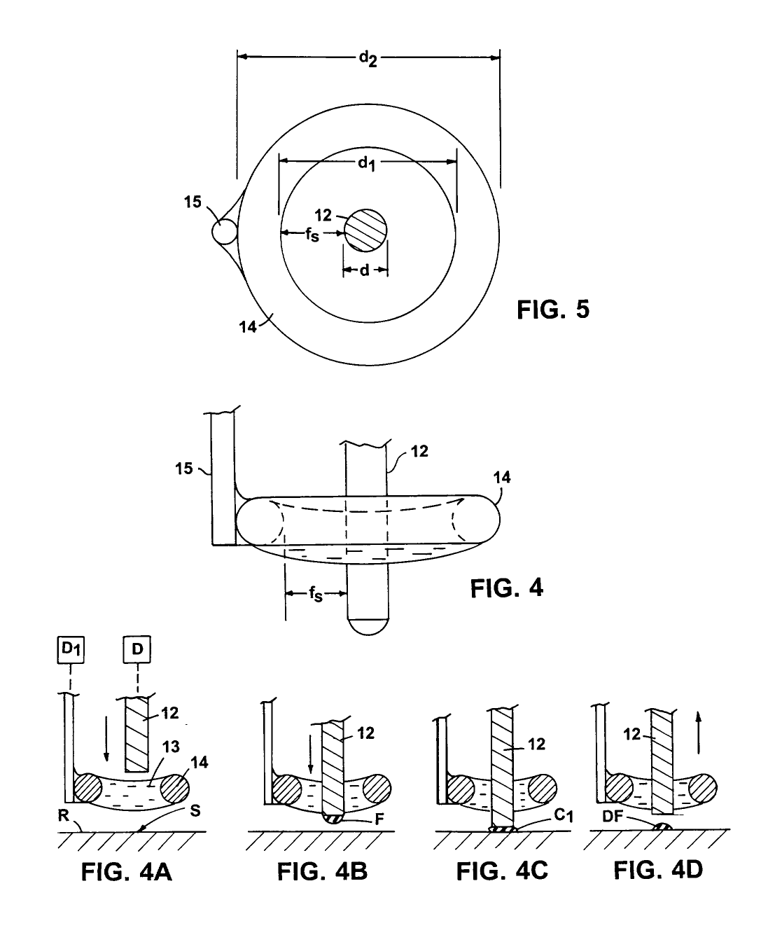

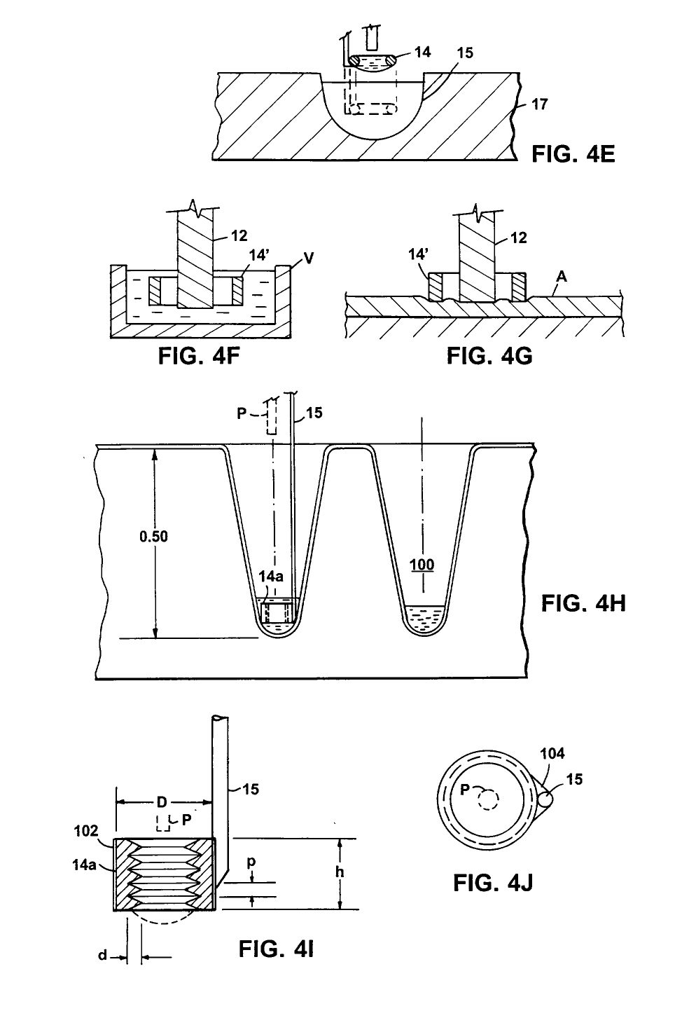

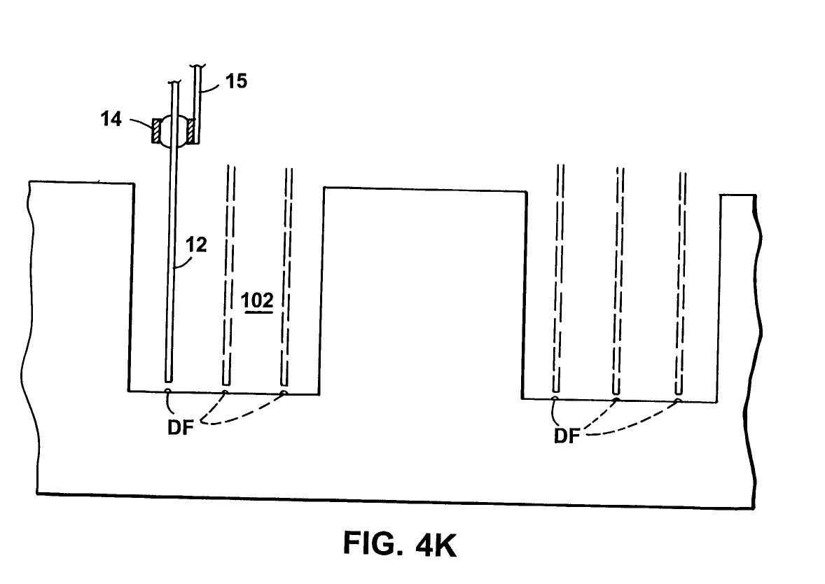

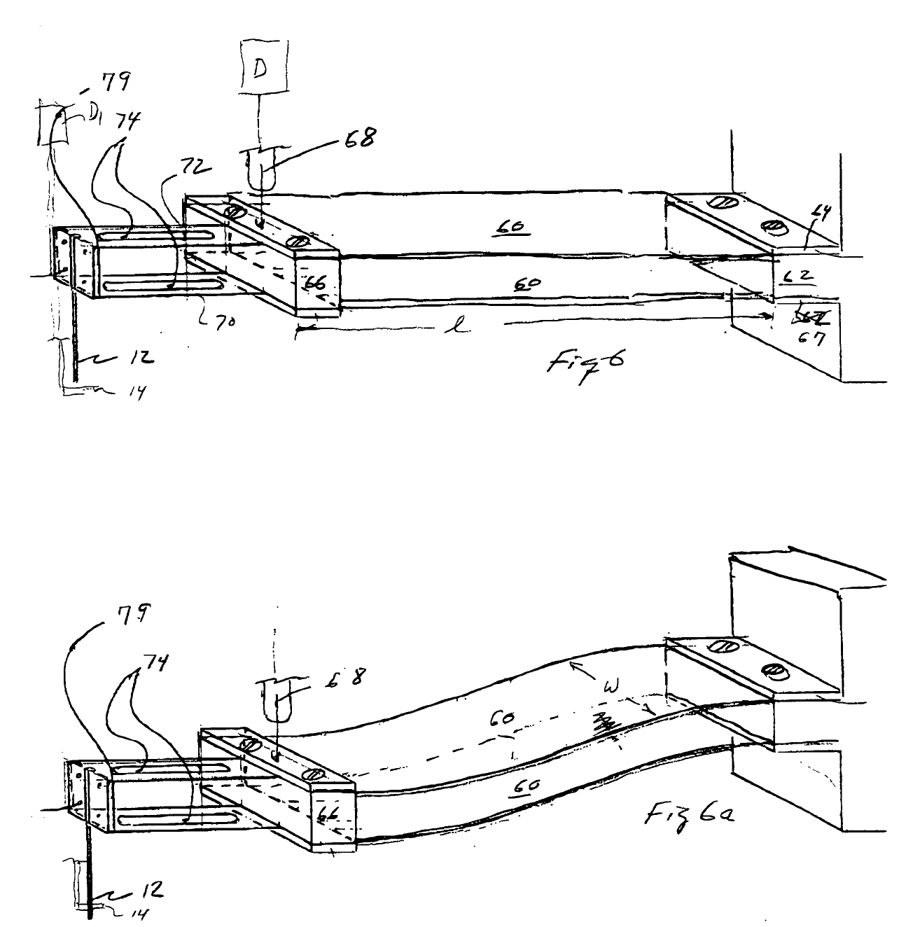

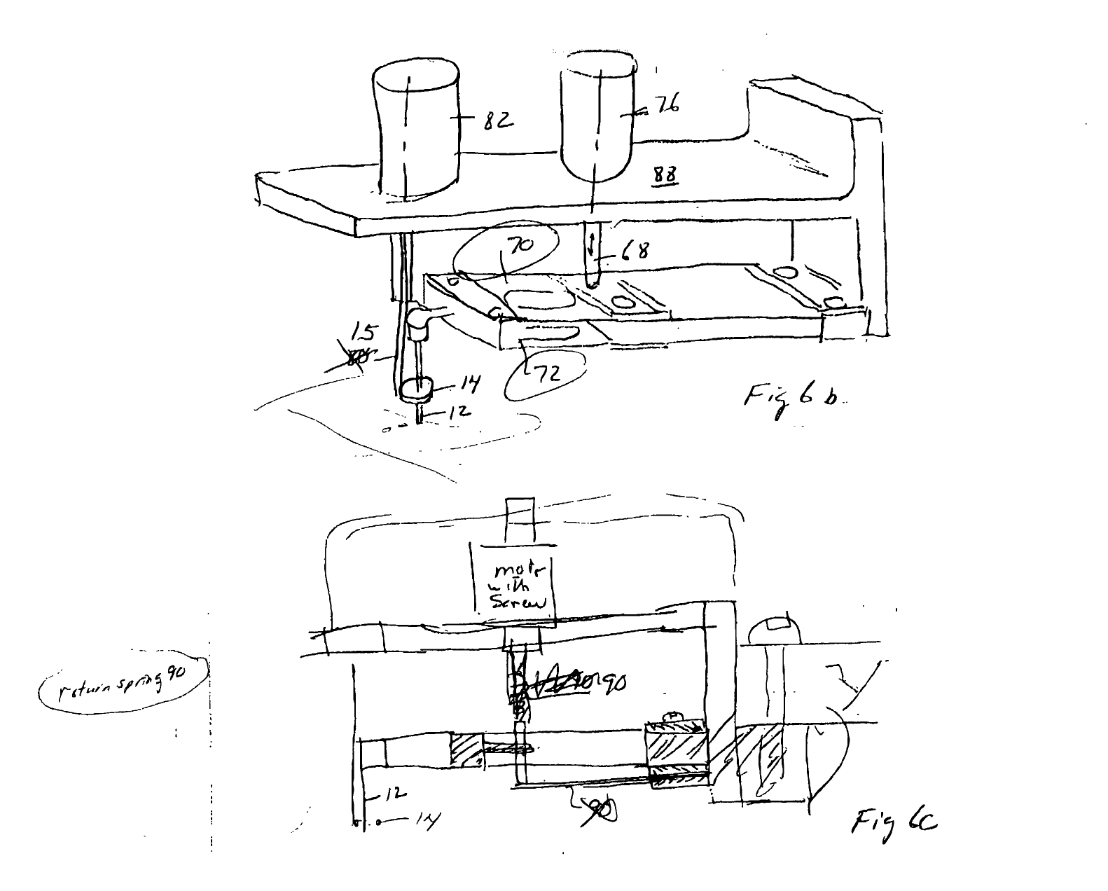

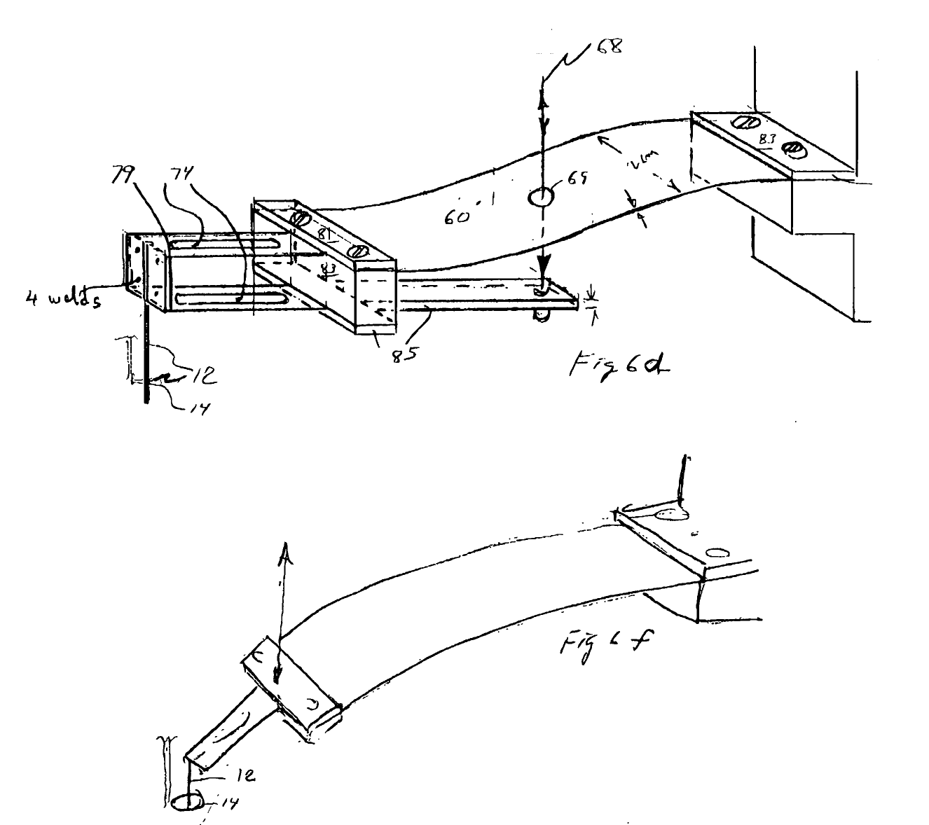

Referring now to FIGS. 4 and 5 a preferred mobile sub-reservoir for the biological fluid or reactant is shown, in the form of an annular ring.

Deposit pin 12 is of diameter d selected in accordance with the size of the deposited dot desired. It is mounted in axi-symmetric relation to the sub-reservoir ring 14 that has a significantly larger internal diameter d₁, such that a significant fluid space fs exists between the pin and the inner periphery of the ring. As shown in FIG. 4E, the outer diameter d₂ of ring 14 is sized smaller than the well 19 of a central supply plate, 17, so that the ring can be immersed in it, for supply or resupply.

During the deposit sequence of FIGS. 4A-4D the ring 14 is held stationary by its support rod 15 while the pin 12 is moved by an associated driver (see e.g. driver 76, FIG. 6B) through a sequence of vertical positions. In the pickup position, the end 11 of pin 12 is drawn above the lower surface of the large fluid drop 13 that is held by capillary action within the internal annular surface of the ring 14. This is shown in FIG. 4A. The pin, for illustrative purposes, is shown withdrawn fully above the retained fluid 13, although that is not necessary.

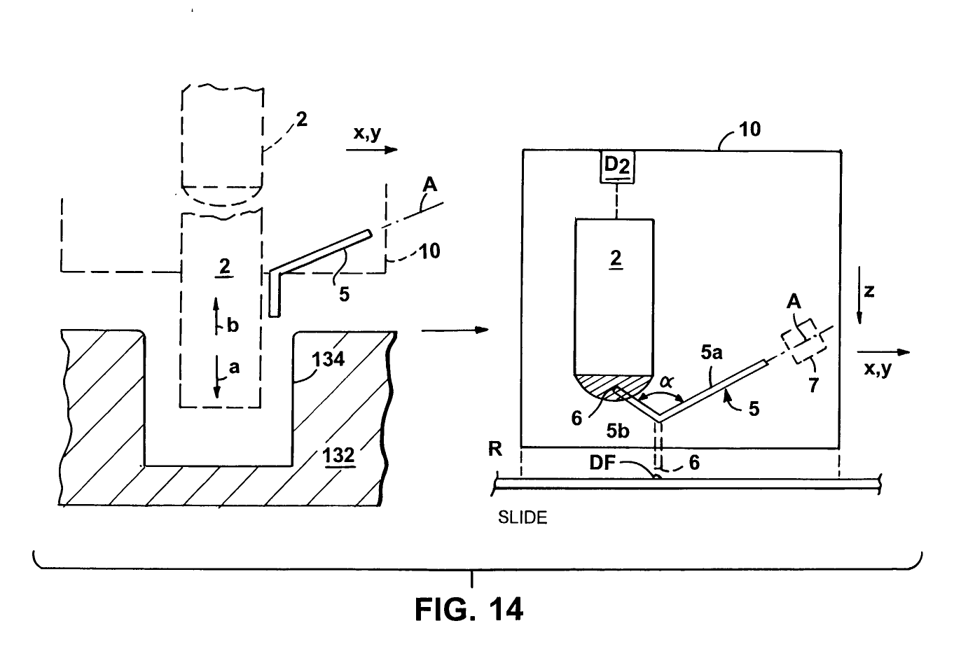

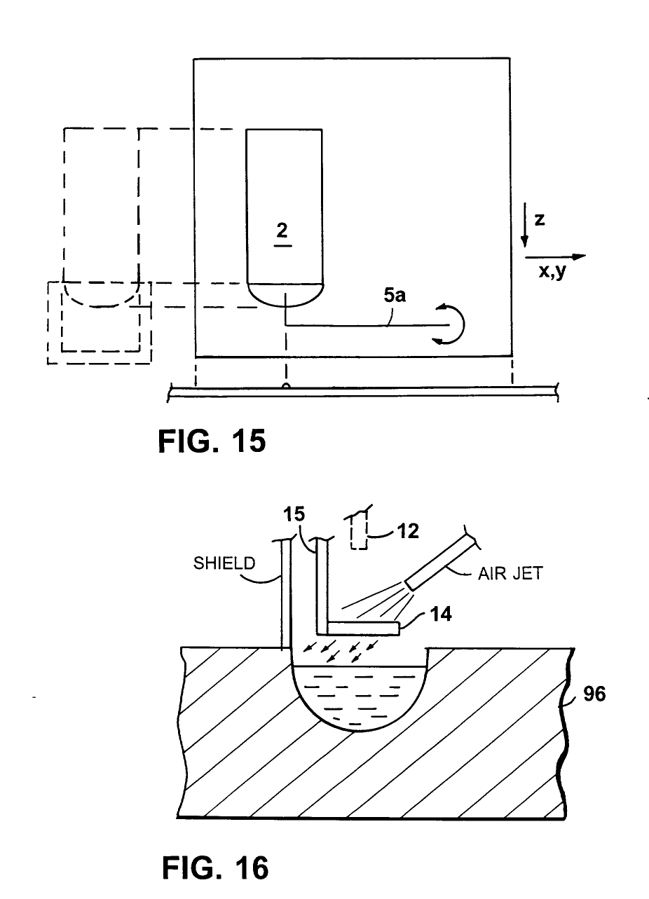

As seen by comparison of FIGS. 4A and 14B, by downward movement of the pin tip from above the lower surface of the large fluid drop 13, to below that surface, the pin picks up a precisely sized drop F, which is then deposited in the sequence shown in FIGS. 4C and 4D.

At the resupply position of FIG. 4e, the annular ring 14 is moved downwardly by its support rod 15 for immersion in the well of the supply plate while the pin 12 remains stationary, at a higher elevation. At the cleaning and drying station the lower surfaces of the pin and ring are shown aligned in FIGS. 4F and 4G. At the washing station, FIG. 4F, the ring and pin may both be subjected to reciprocation in the vat of cleaning solution in the same or opposite vertical directions to assist the cleaning process, and at the drying stage FIG. 4G to assist in blotting against the absorbent layer A.

Wells of 96 well plates used for deposit of the restricted amounts of fluid resulting from PCR (polymerase chain reaction) present a particular problem in fluid transfer. Referring to FIG. 4H, wells 100 are made to hold extremely small volumes of fluid, typically 2 to 5 micro liter (1 micro liter=1 cubic mm). These wells are typically cone-shaped with the top diameter about 6 mm and the bottom shaped as a semisphere about 2 mm in diameter. Fluids even with low viscosity, for instance water, are so held by surface tension in such a well that volumes up to 15 micro liter can be held against gravity when the plate is inverted. Smaller amounts of such liquids are difficult to extract from such narrow wells due to the aggregation of surface tension, gravity, inertia and vacuum effects.

An improved ring construction for removing fluid from such wells has an internal surface roughness of at least 1000 micro inch. This causes the central region of the ring effectively to have superior hydrophilic properties, i.e. a better “grip” on the fluid by surface tension effects. This permits the uplift of a suitable volume of fluid from a container of approximately mating shape. The performance is further improved by the provision of a hydrophobic coating on the exterior of the ring.

The surface roughness of the internal surface can be obtained by sanding, broaching or by machining the part on a lathe with a tool or a tap. The ring can also be manufactured from suitably coarse particulate material that is sintered or molded with a binder. Likewise a durable coating can be applied such as formed by carbide particles.

As shown in FIG. 4I, in a presently preferred embodiment, a cylindrical ring 14A of stainless steel has a height h of 0.050 inch and an outer diameter D of 0.60 inch. It is tapped by a tool having 80 threads per inch, that produces a thread height d and pitch p of 0.060 inch, (with an internal diameter much larger than the deposit pin with which it is used). As shown in FIG. 4H, annular ring provided with internal surface roughness in this way is effective to pick up fluid from the conical well of a PCR plate. Despite the desired surface tension effects produced by the internal ring surface, it has smooth surface increments that promote good cleaning. A hydrophobic coating 102, (duPont Teflon) applied to the exterior surfaces of the ring, assists in the pickup and withdrawal of fluid.

Also shown in FIGS. 4I and 4J is support rod 15 e.g., of 0.15 inch diameter stainless steel wire, soldered at 104a to the exterior of the ring to drive the ring in its motions.

Referring to FIG. 4K, a deposit device, comprising deposit pin 12 and subreservoir ring 14 supported by rod 15, is used for depositing an array of dots of fluid on the bottom of a conventional flat-bottomed well of a microtitre plate. A number of precisely located deposits DF can be made, taking advantage of the long length and small diameter of the deposit pin 12, which affords it the mobility to reach the bottom of the well at numerous precisely spaced locations across the bottom of the well, to produce a desired array.

In this way, for instance, a series of probes may be bound as dots to the bottom of a well, a fluid containing the analyte may be used to fill a well, and subsequent to a reaction or incubation interval, the bottom of the well may be scanned by the microscope referred to above, or otherwise examined, for determining which probes matched the analyte fluid. By pre-preparation of such a plate with known sets of probes, many fluids may be assessed or many probe actions with a given fluid may be assessed.

### C. Operating Systems

Some examples of techniques for implementing the foregoing principles will now be described.

Referring to FIGS. 6 and 6A, and the assembly of FIG. 6B, deposit pin 12 is mounted on a parallelogram, cantilever construction. Spaced-apart planar flexures 60 are mounted in parallel on a mounting block 62, sandwiched by mounting plates 64 and 67 against the intervening block 62. These flexures extend in cantilever fashion to intermediate block 66, arranged to be engaged by pusher rod 68 associated with a prime mover 76, FIG. 6B. Extending further in cantilever fashion from intermediate block 66 are parallel flexures 70 and 72 which include cut-outs 74 that render the flexures weak and highly flexible (compliant). At the end 79 of weak flexures 72 and 74 is mounted deposit pin 12. The condition of no force being applied to the structure is shown in FIG. 6 in which the flexures extend in substantially straight, parallel, horizontal fashion, the weight of the pin being borne by the mounting structure. In FIG. 6A, force is applied in the direction of the arrow 68, downwardly toward a deposit-receiving surface. This results in deflection of the stiff flexures 60 to the shape shown, such that block 66 remains parallel to the receiving surface and deposit pin 12 remains in perpendicular position to the receiving surface as is also shown in FIG. 6. (Thus the relatively stiff flexures 60 and the associated driver perform the function of a precision stage.)

The flexures may be comprised of synthetic resin cut to shape, e.g., Kevlar™, a duPont trademark, for a polyamide resin, or etched from thin spring metal such as beryllium copper or stainless steel. Advantageously both the stiff and weak flexures are formed continuously from a single sheet of spring stock.

In FIG. 6B the assembly of FIG. 6 is combined with further structure to comprise a deposit head. Pusher 68 is associated with a rotary motor 76 which drives lead screw, not shown, and pusher 68, to produce the desired vertical motion. The sub-reservoir ring 14, mounted on support rod 15, likewise is associated with motor 82 and lead screw, not shown, for producing vertical motion of the ring.

In operation, the motor may advance the pusher 68 a predetermined distance from a home position for each deposition action, or to the level of a position sensor which terminates the motion. The microscope slide surface R may lie at slightly different levels due e.g. to permitted manufacturing tolerances of the slides. The stop position of pusher 68 involves sufficient overtravel to ensure contact of the deposit pin 12 with a microscope slide of the least thickness within the tolerated range of thicknesses for such slides. The compliance provided by flexures 70 or 72 (or the other arrangements discussed above, ensure that if the microscope or other substrate is considerably thicker than the thinnest, that the deposit force will not exceed a predetermined value, typically less than 1 gram, e.g. 0.5 gram, to ensure precise dot formation.

In FIG. 6c is shown a variation in which a return spring 90 extends between the support plate 88 on which the motors are mounted and the flexure structure. The spring ensures contact of the pusher 68 with the flexure structure and quick return of the deposit pin 12 from engagement with the microscope slide or other receiving surface upon backing motion of the lead screw associated with pusher 68. A further cantilever spring member acting from below is also shown in FIG. 6C, for likewise maintaining engagement of the flexure structure with the pusher and provide for quick return in a stable manner.

In FIG. 6D a variation of the structure is shown in which a single cantilever and rearward extension carries the deposit pin in a similar parallel motion.

FIG. 6E shows the flexure stamped from a sheet of spring stock, the weak flexures 70, 72 being integral with the outward end of the flexure 60, the structure being bent at notches N.

FIG. 6F illustrates a single flexure embodiment which is capable of performing under conditions under which the travel of the system is not great.

The various flexure support systems illustrated in FIGS. 6-6F, when adapted for high speed deposit, advantageously include damping layers, or a separate damping (or shock absorber) feature combined with metal spring layers or separate metal spring return members to provide stability, for reasons previously discussed.

In FIG. 6G is shown another pin and ring sub-assembly. In this case the deposition pin 12 is mounted in guide bushing 13 to enable it to move up and down. A cylindrical sub-reservoir ring 14 carries the fluid. A guide rod 15 constrains the ring to move up and down. A bushing 16 holds guide rod 15. With suitable actuators, the pin 12 can move up and down on its bearing system and the sub-reservoir ring 14 can move up and down on its bearing system to carry out the various motions previously described with reference to FIGS. 4-4I.

FIG. 7 shows a deposit cluster 28, formed by e.g. any of the assemblies of the FIG. 6 series. Cluster 28 includes, not shown, a number of independent drives, D and D′, to drive the pins and rings in Z direction for picking up and depositing fluid, and sensors to indicate to the control electronics the position of the operative elements. There is a home sensor for each deposit pin 12 and a home sensor for each ring 14. The devices are ganged mechanically for X or X, Y movement, positioned by a common electronic control.

The cluster 28 may step to a selected X, Y position, at which a number of different motions may be caused to occur, under computer control, picking up and depositing fluid in any order at any location desired. Such a cluster constitutes a particularly versatile tool when employed with conventional microtiter plates.

In such embodiments the aliquot carrier rings 14 and pins 12 are spaced in the cluster at 9 mm center-to-center distances or multiples thereof. This arrangement facilitates operation with conventional “96 well plates” in which the wells are spaced at 9 mm on center intervals with 8 rows of 12 holes. Higher density plates also employ this configuration and have the same footprint but employ more holes, 16×24, with hole-to-hole distance of 9/2 mm, to provide “384 plates”, an arrangement which enables use of the higher density plates with existing automated 96 well plate handling equipment. The system described can be employed with both types of plates, as well as any arbitrary arrangement.

The versatility of the cluster is illustrated by the following examples.

Sub-reservoir rings, e.g. set at 9 mm center-to-spacing, may be indexed in X, Y direction along with their pins and the rings driven down simultaneously for supply or resupply from four wells of a conventional 96 or 384 well plate.

After suitable indexing, the four pins may be driven down simultaneously to form deposits at four places, in the same format as the supply plate. These deposits are used, e.g. in the process of making arrays on separate microscope slides.

Instead, one subreservoir ring may be dropped to pick up material from a selected well while all others remain in their passive positions. Then the cluster may be moved until the next ring arrives at the same well or another selected well, and so on, so that all of the rings may have the same fluid from the same well or selected different fluids.

The cluster 28 may be moved in X, Y direction between pickup or deposit actions of successive pins so that, e.g. all of the pins deposit the same or different fluid on a single slide at selectable addresses or each pin addresses a different slide, but at a different location, or two pins address one slide and two another slide.

The operator may also choose not to have one or more of the devices operating. Thus it is seen that dense clustering of deposit pins and rings can enable high speed, versatile operation.

An alternate class of head has a number of aliquot carrier rings 14 and a number of deposit pins 12, all aliquot carriers actuated simultaneously by one actuator and all pins actuated by another single actuator, to provide a multiple pin head.

Thus, referring to FIGS. 7A, 7B and 7D, using linear stage techniques, two rows of four pins 12 at 9 mm spacing in both X and Y directions are all mounted on a frame 120 which is reciprocated along rail 160 via carriage 162 by a single motor D. This causes the eight pins to move simultaneously. Likewise, two rows of four cooperating rings 14 are mounted on ring support 124, with the same spacing. The single support 124 is also driven via carriage 126 by one motor D′. In the embodiment shown, both embodiments share the same guide rail 160. The pattern of dots shown in FIG. 7C is formed by a single actuation of motor D.

The gantry of an arrayer now to be described, can carry one deposit head, a cluster of single pin heads, or a multiple pin head. Combinations of these are also possible.

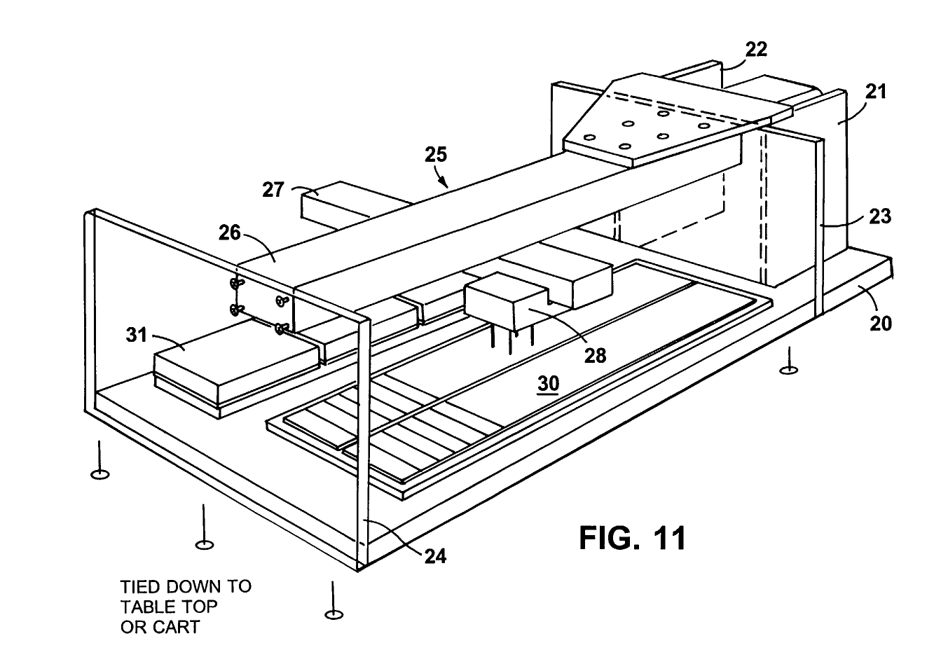

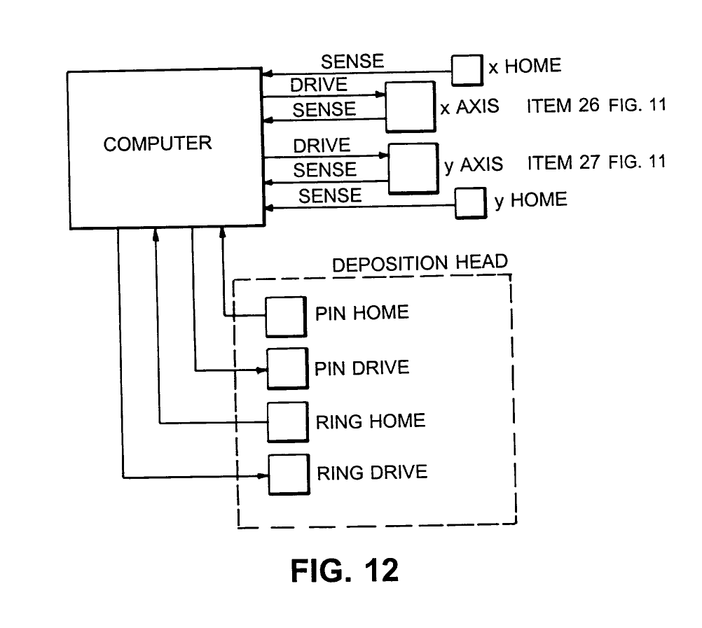

FIG. 11 is a perspective view of a slide preparation machine for preparing microscope slides. Its function is to deposit, in rapid manner, a high density array of fluid dots of different compositions on a number of identical microscope slides, employing microdot technology of the present invention. As shown in FIG. 11, there are four 96 well plates 31, serving as the central fluid source.

Horizontal base plate 20 provides a support structure to hold the operating components. Fastened to base plate 20 are vertical sub plates 21, 22, 23 and 24. Fastened to these plates is a dual axis motion system 25, comprising X and Y axis devices 26, 27 for providing X and Y motions, in a parallel plane.

The guide rails of the X and Y axis devices, 26, 27 are parallel to base plate 20, to carry deposit cluster 28 in X, Y motions in a plane parallel to base plate 20.

The X axis device 26 is a commercial device available from Adept of Japan. It moves at a high rate of speed in a controlled manner using a rotary servo motor with a drive screw and a shaft position encoder, employing digital and analog technology. Carried by X-axis device 26 is an orthogonally arrayed Y-axis device 27 which is a smaller version that operates in the same manner as the X-axis device.

The deposit cluster 28 comprises four deposition mechanisms, ganged together on a mounting structure as shown in FIG. 7. These devices may be in accordance with the various structures shown in the FIG. 6 series. Except for FIG. 6G, methods of mounting and actuation have been described above.

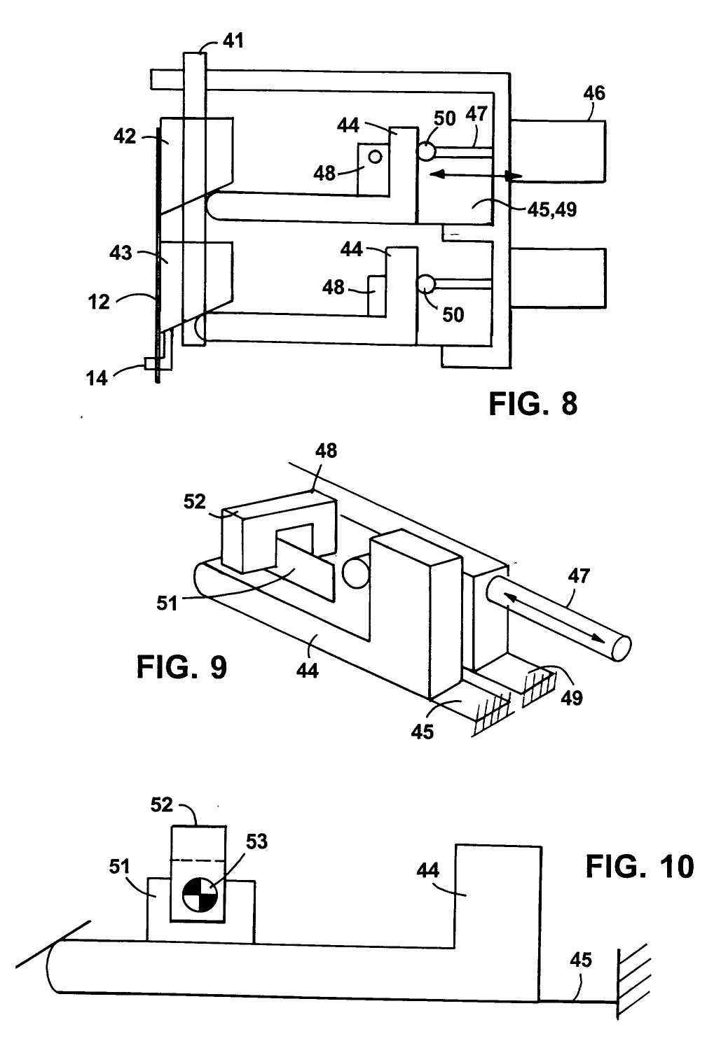

FIG. 8 shows a mechanism to drive the pin and ring arrangement of FIG. 6G.

In FIG. 8 the ring 14 surrounding the pin 12 is mounted to a guided block, 43, while pin 12 is fastened to another guided block, 42, blocks 42 and 43 being guided by rod 41. In addition their rotation is constrained by two lever elements, 44 which are substantially identical.

As also seen in FIGS. 9 and 10, the levers are supported by flexures 45 to give precision to the mechanism. The system is capable of making spots that are as small as between 20 and 35 microns in extent with 40 to 70 microns pitch. As with the previously described embodiment, the flexures avoid lost motion, to enable such accuracy.

The levers are driven by stepper motors or analog servo motors 46. The several motors have integral to each a fretted shaft, 47 which protrudes from or recedes into the body of the motor as the motor is commanded to move. As indicated by the arrow, the motion is bi-directional, parallel to the rod that protrudes from the motor, and serves to lower the pin or the ring into its respective working location.

In this embodiment, the motor does not work directly on the lever 44. The lever 44 and its support flexure 15 plus the block 42 or 43 that holds the pin or the ring, is designed so that under no force from the motor 48, the rest position of the end of the pin or the end of the ring is exactly where it is going to be working. When the deposit pin 12 comes close to the microscope slide on which a deposit is desired, there is essentially no force. As before, by minimizing the force on the end of this pin, presentation of a fluid film layer under the pin is maintained, to give long pin life. The potential of a large force when the pin comes in contact with the slide, to cause fluid to splatter is avoided.

Intermediate plate 48 is provided, which the motor shaft 47 presses against. Plate 48 is also supported by a flexure 49 which is parallel to the flexure 45 which supports the lever 44 and directly controls the motion of the pin and the ring. Flexure 49 supports the intermediate rocker, 48, which is pushed upon by the motor. As the motor pushes, members 48 and 44 rotate together, because initially the mechanism is supported by plate 48. When the deposit pin either contacts the substrate or the deflection of flexure 45 is sufficient to support the weight of the pin mechanism, lever 44 stops rotating as the motor turns. Plate 48 then continues on until the motor is commanded to stop moving. By this means, the force of contact between the ring and the bottom of the plate are limited.

As shown in the drawings, there are two such drive mechanisms, one with respect to the pin and the other with respect to the ring, which are substantially identical.

FIG. 9 shows the actuating screw of motor 47 pushing against intermediate rocker 48. It is seen that rocker 48 is supported by flexure 49. Flexure 49 is relatively stiff and strong enough to easily support the weight of the moving parts. Flexure 45 is a relatively weak flexure, designed to just support the weight of the pin or the ring at the extremes of motion. As the device is actuated by the motor, rocker 48 rotates flexure 49 and the lever rotates with it on its own flexure. When the weight of the moving part is essentially supported by the deflection of flexure 45, the lever ceases to move and so does the pin driver 42 or the ring driver 43, whereas member 47 can continue to push the rocker as far as it can without causing any loads to be imparted into the lever or to the pin or to the ring.

The levers 44 have arcuate surfaces machined on their ends and the guides themselves have a slope so that the contact force between the lever and the moving parts will be normal to the sloped surface. Thus, as the lever rotates, although the contact position changes the angle, the force vector between the lever and the moving part is always parallel to the moving block, normal to the slope surface. This ensures that the force vector does not change direction during its motion, thereby causing the mechanism to rock or tilt.

This system can employ motors that do not know where they are, but means are provided to tell the control system that the lever is in a particular position, commonly referred to as “home”. In FIGS. 9 and 10 the lever 44 has a small protrusion, typically a piece of sheet metal 51, which in home position, interrupts the beam of an optical sensor 52.

The light beam issues from one leg and is detected by the other. This is shown in the home position in FIG. 10 where the light beam has just been completely occluded by the flag, 51. When the lever is driven counterclockwise in this view by the gravitational force acting on the guided part, the flag falls out of the gap in the sensor and the light is detected. The control system is then told that the lever is in motion or not in home position.

This is utilized in initialization of the instrument. When the computer and associating control electronics are turned on, the sensors are interrogated by the control system. The motor is stepped so that the respective pin or ring is driven down and the sensor is interrogated again, and it will be stepped down until the sensor indicates that light is passing. At this point the control system knows where the lever is and then it will be set one or two steps back to the home position and the control system thus knows where the lever is. It is a characteristic of stepper motors, that, when driven properly, they will thereafter execute the number of steps that they are commanded.

As will be understood, similar controls may be employed with the assemblies of the other arrangements shown in the series of FIG. 6, when employed in the system of FIG. 11.

In the system of FIG. 11, the array of pins and rings of a cluster 58 may be held over a vessel of water for cleaning, as shown in FIG. 4f. The vessel has water level and a pump constantly stirs the water. Also associated in FIG. 4g is a tile of blotting paper or in some implementations, a cellulose sponge. In operation, following washing, the array of four ring and pins are touched upon the blotting paper for drying.

The X, Y control of the system of FIG. 11 can accurately position the devices so they contact fresh areas of the blotter each time. The computer keeps track of the positions that have been used and guides the deposit head to new positions.

After the deposition sequence is complete, the X and Y terminal drives the cluster of depositing elements to the cleaning station. In some embodiments they may be passed over the wells from which the fluid originated and subjected to air blast, see FIG. 16 or by abrupt stopping of rapid downward movement to return excess fluid to the wells. At the cleaning station the depositing elements are positioned over a clean part of the blotting paper or sponge, FIG. 4G, and then both the pins and the rings are driven to contact the sponge. With a small application of force the parts catch up with each other and become co-planar. After a short interval the fluid is wicked from the rings and pins. Then the multiplicity of devices is lifted and thrust into the container of water, FIG. 4F. The water is constantly agitated and the devices are exposed to substantially fresh water as they are being rinsed. The main servo system of the X or Y axis can be employed to move the rings and pins e.g. in swirling motion to effect stirring or agitation. The deposit pins and the rings are then lifted from the water tray, FIG. 4F, and brought to the blotting tray or a fresh blotting tray where the rinse water is blotted from the rings and pins to provide substantially dry devices for the next fill and deposit cycle.

FIG. 12 shows the control system of the machine. It shows the controls for the X and Y axis movement and also home center for the X and Y axis. As with a stepper motor, the position of these motors is sensed by a flag to tell the controller precisely the rotation angle of the motor. The actual position of the carriage that the lead screw is driving is also sensed so the carriage can be driven home and then the counter is initialized so precision motions can be made along both the X and Y axes. Also shown is a schematic of the deposition head, one of many. As previously described, each deposition head has two motors, a pin drive motor and a ring motor, that are commanded from the control computer.

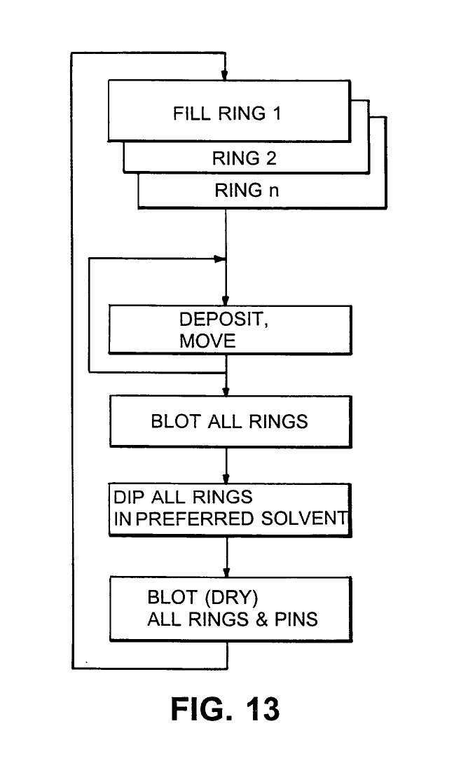

For deposit on microscope slides, the slides are fastened to the table, or placed in register with guides in a known position. Features on the base plate of the machine locate the slides in predetermined orientation. The slides are mounted in subgroups of five slides. The fifth slide's position is dependent only upon the tolerance of the preceding four slides. By having such sub groups one is assured that the array is properly located. The computer is enabled to talk to the slide and record information, as in bar code. The bar code reader is mounted on the servo drive 27 of the Y axis and adjacent to the deposition means 28. The sequence starts with filling the multiplicity of rings of the deposition, and is carried out according to the control procedure of FIG. 13.

FIG. 14 shows another single drop deposit head 10 which comprises a sub-reservoir in the form of a large pin 2 and a relatively small deposit pin 5.

Large pin 2 is shown supplied with a large fluid drop 4. This may be accomplished by visit to central supply station as previously described. The large pin 2 may be sized to enter well 100 of the plate shown in FIG. 4H to withdraw drop 4. The surface of pin 2 is advantageously roughened to a surface finish of at least 1000 microinch to increase its ability to withdraw fluid from the well and hold it as a large aliquot drop 4.

Sub-reservoir pin 2 is lowered from head 10 in direction a for pickup of its large drop and is withdrawn, b, after the drop has been obtained. Head 10 is then translated by X, Y stages to the point where deposit is desired, as previously described.

The deposit pin 5 is of diameter between about 0.002 and 0.010 inch for deposit of drops from its end 6. Pin 5 has a main shaft 5a that lies along axis A at an angle α of about 30° to the horizontal, and a deposit leg 5a set at angle of 120° to axis A. Shaft 5a is mounted to be rotated 180° by motor 7 between pickup position, in which end 6 of the deposit pin enters the large aliquot drop 4 that depends from sub-reservoir pin 2 (shown in solid lines), to deposit position, shown in dashed lines, in which leg 5b projects vertically downwardly. When leg 5b thus reaches deposit position, head 10 is lowered in direction Z until pin end 6 deposits its drop upon surface R of the microscope slide. The vertical compliance of shaft 5a accommodates variation in thickness of the microscope plate, and provides a soft landing of the pin upon the substrate. After deposit of fluid drop DF, the head is moved in X, Y directions, to another position, shaft 5a rotates so that tip 6, now devoid of fluid, again enters sub-reservoir drop 4, to be provided with another drop for deposit, and so on. The considerations that govern the sizing of drops to be deposited by tip 6 of deposit pin 5 are the same as discussed with reference to the FIG. 1 series. The advantages of having a mobile sub-reservoir, here in the form of large pin 2, are also as previously described.

FIG. 16 illustrates a recovery system in which unused fluid retained by the local sub-reservoir, here represented by annular ring 14, is returned to the well from which the fluid was obtained.

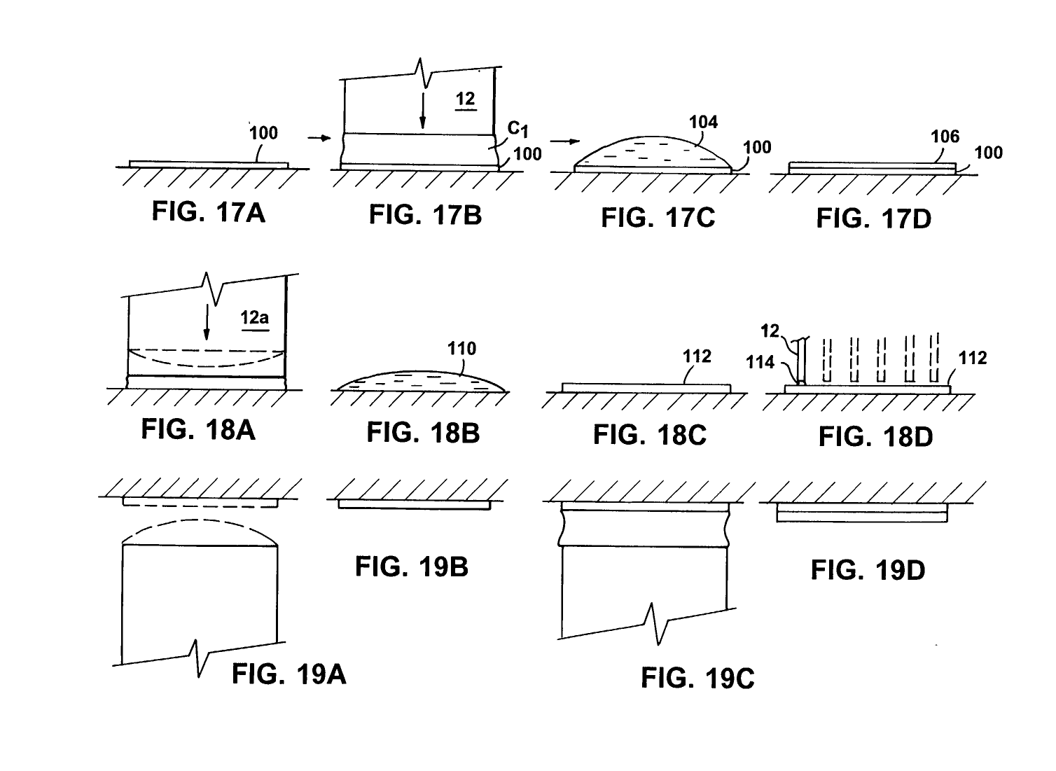

FIG. 17 depicts the process of depositing one deposit upon another in a precisely aligned manner, made possible by the positional accuracy of the systems described. In particular, the high accuracy of placement enabled by the simple support of deposit pin 12 by a parallelogram arrangement of planar flexures, see e.g. FIG. 1F or FIG. 6, is of particular advantage in this context. FIG. 17 shows a dried deposited dot 100, as produced by techniques previously described. FIG. 17B shows deposit pin 12 having been indexed into precise alignment with dot 100, and lowered to engage drop C′ with it. FIG. 17C shows the deposited second drop 104 while still in fluid state while FIG. 17D shows dried second dot 106 deposited upon dot 100.

In similar fashion FIG. 18-D illustrate deposit of a relatively large spot of fluid using large deposit pin 12 and subsequent deposit of small drops using a smaller pin 12. The large drop on the pin 108, in FIG. 18A, forms a large deposited drop 110, FIG. 18B, which dries to form a large dried spot 112, FIG. 18C. Subsequently, small drops 114 are deposited in selected locations upon the large spot 112.

FIGS. 19A-D illustrate the possibility, with selected receiving substrates and fluid, of conducting the operation of FIG. 17 in inverted fashion.

For use in high volume production contexts, the system described preferably employs a rapidly moving compliant pin, in a deposit cycle of less than 0.1 second, in which impact and vibration is minimized, with the natural frequency of the system more than 10 Hz, in many cases preferably 20 Hz, a pin contact pressure of less than 1.0 gram, in many cases preferably about 5 gram, and the system employing a stable metal spring return element and a damping element.

Pin pressure on the substrate is light, and fluid splatter or separation conditions are thus avoided, despite the high speed of action, so that dots of fluid of uniform shape are consistently formed at precisely controlled positions.

While the cantilered parallelogram flexures with a lamination of absorbent materials is preferred as highly reliable and inexpensive, other arrangements for achieving stability, as by use of metal tension or compression springs or one or a pair of parallel microspider spring flexures arranged axially of the pins. Likewise, other forms of damping may be employed, including, e.g., intentionally introducing a degree of friction in the sliding of guides 13 and 16 on the respective shafts to act as damping devices.

However implemented, in the deposit action, by immediately raising the pin after contact of the drop on the substrate, the combined effects of gravity, inertia of the stationary fluid, and surface tension act upon the drop of fluid to overcome the force of surface tension exerted by the smooth lifting pin. The fluid drop preferentially stays with the surface of the substrate, and the pin, devoid of fluid, is free to be replenished to form a deposit and move rapidly to its next destination.

As the volume of the fluid is accurately determined by use of a standard size of pin, and standard conditions, and the position of the pin is precisely constrained, spots of consistent size and precise location are produced, that enable an improved degree of quantification of observed results.

### D. EXAMPLES OF USE

The system is useful with any native fragment of DNA, or pre-synthesized oligonucleotide of any length. There being no restriction as to chemicals, any non-photoreactive chemical can be employed, likewise dyes that are useful to detect presence or absence of DNA may be selectively deposited in registry with previously deposited spots of biological material, and vice versa.

Among the many biological materials that may be spotted at high speed are fragments of nucleic acids, e.g. DNA, RNA or hybrids such as PNA (peptide nucleic acid), PCR (polymerase chain reaction) products, cloned DNA, and isolated genomic RNA or DNA, as well as synthetic analogs.

Also included are restriction enzyme fragments, full or partial length cDNA, mRNA or similar variations thereof, proteins such as protein receptors, enzymes, antibodies, peptides and protein digests; carbohydrates; pharmaceuticals; microbes including bacteria, virus, yeast, fungi, and PPLO; cells and tissue fragments; lipids, lipoproteins, and the like; plastic resin polymers, small particulate solids in suspension, etc.

The deposition system may also be employed to deposit catalysts and reagents upon previously deposited material of any of the types above or, as mentioned, to create an array of sites or micro-wells for later reaction or growth of such material, or to assist in neutralizing or cleaning the deposit or reaction sites, as in the case of highly toxic or virulent substances.

The most basic use of the arrayer is to create high density arrays of nucleic acid on a solid, flat surface, most generally a microscope slide. However, deposit on fragile glass cover slips, plastic surfaces, and wells of a microplate, or any substrate, which may be previously coated or derivatized, may serve as a recipient surface.

In particular, fragile glass cover slips are desirable as being thinner than microscope slides, easier to maneuver, and when a beam of light is transmitted through them for transmission microscopy, better light capture occurs, because the slip is thinner and less absorptive than a slide.

The system also has the capability of spotting on plastic surfaces without scarring or deforming the surface, to enable advantage to be taken of intrinsically low auto-fluorescence of plastics when fluorometric measurements are to be made.

The avoidance of surface deformation can be important, enabled by use of low contact forces. An undeformed surface can facilitate viewing with a confocal microscope, as it assures that the deposit remains in the plane of focus.

Use in wells of microplates is important. As has been mentioned, the narrow lateral dimensions of the pin, and its long length enable deposit in multiple locations on the bottom of a well, or other fluid containment region. For example the arrayer may be employed to deposit a number of spots in known locations on the bottom of a well to perform clinical tests on an analyte fluid. For instance, each spot in an array in the bottom of a well can be a known nucleotide probe. A sample added to the well will hybridize with spots with which the sample matches. For instance a diagnostic test may employ a 96 well plate to measure binding to as many as a hundred different probes printed in known locations in the bottom of each well. Different patient's samples may be placed in respective wells, to conduct many evaluations at once.

Another use of the system is to deposit, at useful speeds, a single biological cell into a single well. Employing a suspension of suitable concentration of cells in a supply ring with an appropriately sized pin, thrusting the pin down once per well, statistically, can deposit one cell per well, which then can interact with nutrient, experimental drug, etc. in the well.

The concept of insertion is extended to include the deposit of particulates in suspension, for example, to deposit cells and then afterwards, deposit a suspension of particles of asbestos or precipitated silica or other solids of interest, to investigate effects of the particles upon the cell. These are examples of inexpensive, highly accurate micro-controlled experiments that can be conducted at efficient speeds using the dedicated aliquot reservoir and deposit pin.

In many important cases the fluid or liquid carrier of the deposited spot evaporates and the biological or other material carried in the fluid stays in place by adhesive or bonding properties of the dried material. In other cases, the spotting technique is useful to deposit fluid that remains in a fluid state, for instance, as mentioned, to deposit a single cell into a well with fluid nutrient medium that enables the cell to continue to live.

In many cases it is important to know where a deposit is and that it will stay in the deposited position when covered by a common reagent. Steps can be taken to secure the deposit in position, for instance, with DNA, by exposing the deposit to UV radiation to crosslink the material or to use a derivatized surface that produces crosslinking between e.g. DNA and the surface on which it is deposited. An example is a silenated surface coated with E.S. aminosilene, to provide a positively charged surface which binds, by ionic or electrostatic forces, with negatively charged deposits such as DNA.

In addition to applicability in bioresearch and clinical diagnosis, the deposition system has applicability in the chemical laboratory, e.g. to experiment with resins, for instance polymerization reactions, to conduct experiments in small quantities of many different varieties, e.g. to determine optimum ratios and optimum selection from a host of slightly varying examples. The range of usefulness is broad with application to small quantities, different temporal sequences, different kinetics of reaction, and different mixtures. In all of these cases, the system is a precise way of manipulating small amounts of liquid, solids in liquid suspension and cells in suspension, under controlled conditions. Mention of a few examples will further illustrate this breadth.

Deposition with the systems described leads to precise observations, reduction in the number of trials for a given experiment and improvement in the statistical significance of the data. Cost savings and improved experimental procedures can be realized. Quantification of results at accuracies heretofore unknown may be attained by consistent and precise dot formation that enables improved signal-to-noise ratio in detection, when sensing the difference between, e.g., the fluorescence of a deposited spot and the immediately adjacent background surface of the substrate.

The mobile, local reservoir structure that preferably translates across the substrate with the deposit pin may have various advantageous forms such as axially adjacent circular rings, multi-turn helical shapes, closed cylinders, open rectangular rings, etc. The size of the opening or bore, as well as the size, for instance, of the wire or ribbon that forms the shape of the ring is selected in relation to the properties of the fluid (e.g. viscosity and surface tension), the number of deposits to be made from a given fluid charge in the reservoir ring, and the size of the deposit pin that is to move through the ring.

The size of the deposit pin and shape of the pin also vary depending upon the application. It is possible to employ pins of varying transverse cross-section, e.g. square as well as round cross-section pins. Especially for small dots, the pins may advantageously have stepped transverse cross-sections, e.g. an extremely small cross-section at the deposit end, to size the deposited drop, stepped to a larger cross-section in the main body, for providing structural stability.

The system is capable of use in many environments due to the attributes of the deposit apparatus, and the techniques by which movement and control is effected. The following are further examples.

The system is capable of depositing dots of fluids of high volatility such as alcohol-based fluids, upon rigid substrates such as glass or silicon. The relatively large mobile local reservoir ring that travels with the deposit pin to the deposit site presents a relatively small exposed surface-to-mass ratio, which limits evaporation. Transport from that volume of the tiny sample on the head of the pin, over a short local distance, limits exposure of the tiny sample to evaporating conditions until the dot of fluid is deposited.

Where desired, the operating deposit mechanism can also be conveniently shielded from windage by a protective shield mounted on the head to move in X-Y directions with the deposit mechanism, to further limit evaporative loss. In another case, the environment in which the system operates can be controlled, e.g. at high humidity, or high partial pressure of the volatile substance, to limit evaporative loss.

With the instrument described, time-based sampling to evaluate chemical reactions or growth stages can be performed automatically without attendance of laboratory personnel. In one example, the fluid carrier ring through which the pin operates is employed as a reaction vessel from which samples of the continuing reaction are periodically taken by an associated deposit pin, and deposited for later inspection.

In this or other examples, at prescribed time intervals, another pin moves through its ring to deposit an inhibiting reagent to halt the reaction or growth that is occurring at a respective location on a substrate. By doing this at timed intervals over different locations on an array of identical reactions, a fixed array that represents the sequence of conditions at the various time intervals is preserved for later examination.

Another method that employs the deposit system uses an etchant fluid in a local reservoir ring. The pin of the spotter instrument distributes the etchant in tiny, precise spots or microdots in a desired array across a reactive substrate surface. For instance, for forming micro-wells for containing fluid reactions that are later to occur, the device deposits an acid such as hydrochloric acid in an array of small dots upon a silicon substrate. An etching reaction occurs, and the substrate is then neutralized and washed, to produce a corresponding array of small wells. These may have advantageous hydrophilic, fluid-retaining surfaces as a result of the etching process. Following this, the same depositing system may be employed to deposit one or more substances precisely in registration with each of the wells for use in reaction or growth processes that are desired. Plates thus prepared may be transferred e.g. to a scanning microscope for observation.

Arrayers as described can also be used for color printing of fabrics, paper etc., where the 96 well plate holds different color ink or die. The area to be printed is the entrie reach of the gantry less the color source and washing station.

The arrayer can be used to generate a single printed circuit board, e.g., prototype boards, or boards for limited volume production, where the machine employed to deposit varnish or photoresist or other protective coating material to define the region of the copper clad which need to be preserved from acid etching.

### D. Combination Arraying and Microscopic Analysis

It is an important further feature of the invention to combine the arrayer of any of the presented embodiments, or its steps of action, or array product of its operation, with a flying mini-objective scanning microscope and/or a scanning microscope with autofocus techniques, or their steps of action, as described in the two microscope patent applications that are here incorporated by reference, see above.

Whereas the principles described here enable wide area arrays to be formed of very high density over the mentioned wide range of fluids and conditions, these wide area scanning microscopes enable commensurate accurate and inexpensive reading of the results achieved with such wide arrays. The wide area and precision capabilities of each system and method, in combination, complements the other to achieve an enabling, significant advance in microdot reaction and analysis.

### E. Other Combinations

The deposit principles and the combined arraying and microscopic analysis principles that have been described are useful in combination with other devices systems and methods as well.

In one embodiment, an inductive heater station is provided to which the deposit mechanism can travel under computer control. In this case the substance of the reservoir ring and the deposit pin, or at least the surface portions of these devices, are comprised of electrically conductive material capable of having electrical currents induced by an alternating field of the induction heater. Under computer control, the reservoir ring and the pin are delivered for a momentary pause in the heater, for heating based on resistive (I²R) losses by the induced electrical currents, for instance to sterilize the reservoir ring and deposit pin or to stop bioactivity in the fluid material retained on the instruments.

In another instance, a reservoir ring containing a charge of reactant fluid, which is desired to be heated, can be introduced to the inductive heater, and the fluid is heated by heat-transfer to the fluid from the inductively heated ring. Such heating can be employed to initiate a reaction in the fluid, for subsequent deposit.

Another system includes a delivery system for relatively larger quantities of fluid, e.g. to fill a micro-well with nutrient, diluent or reagent after deposit of a spot of the fluid of interest. The delivery system, such as a computer-controlled pipette, may be associated on the same head and X-Y carriage with the deposit pin, or in a separate head or carriage. By functioning under computer control to deliver larger quantities of fluid to reaction sites where dots of fluid have previously been deposited, an entire experiment can be automated. Fluids which may be introduced in this way include, for instance solvents, etchants, sterilizing agents, cleaning agents, encapsulating coating materials, etc.

In another method the deposit pin is caused to deposit reagents at selected sites in differing amounts at differing locations, to effectively conduct titration, to observe a reaction at different concentrations of the reagent. Thus, at one reaction site (a flat area or a well on a substrate) the deposit pin may deposit one precise drop of reagent, at a second site two precisely identical drops of the reagent, at a third selected site three precisely identical drops of the reagent, and so on, to provide the full range of concentrations desired for evaluating reaction of the reagent with another substance that has been preapplied to the site or that is subsequently applied.

While such systems are particularly well suited for laboratory experiments, they also can be employed in industrial process control.

A variation of the spotter mechanism employs, in a fashion analogous to that of a modern milling machine, a set of interchangeable heads having different capabilities. Under computer control, an X-Y carriage of the system is moved to select a desired head which is carried across the substrate to perform its function. In some instances the device selected may be a sub-reservoir ring from a set of such rings that have different internal diameter or are formed of different wire or ribbon sizes, or are of different sizes to enter different wells. These provide a variety of carrying capacities for fluids of different viscosities or for use with deposit pins of different sizes. Likewise, different sizes of pins can be selected from a set of pins to vary the size of the spot to be deposited. Heads can also be selected that provide other devices for preparing for or conducting experiments or for the production of reference or diagnostic well plates and slides.

In some cases the selection and use of devices can be conducted under complete computer control to enable automatic performance of a multi-task experiment un-attended by the technician.

In addition to depositing spots of fluid upon a standard microscope slide, it is possible and advantageous to deposit spots on substrates of significantly larger area and on substances different from glass or microscope slides, for instance upon substrates having micro-cavities that have been formed by the instrument, by any one of the techniques described above. Plates delivered with the micro-cavities preformed in the substrate may also be used, and aligned for deposit of fluid by automatic controls of the instrument, or the control system of the unit is advantageously provided with a vision system that “reads” the location and pattern of the array of micro-wells, and adjusts itself automatically or under operator control to accurately deposit dots of fluid in them.

F. CONCLUSION

In conclusion, in the various ways described, a large array of sites may be established and managed in a precise, repeatable manner that employ the same concentrations or reactions or precisely varied concentrations and reactions. This may be done to enable examination, to promote reaction or growth processes in biotechnology, life sciences, chemistry, pollution detection, process control and in industry in general.

Thus, beyond an instrument for low-cost preparation of microscope slides for biotechnology research, there has been contributed a universal and widely variable set of systems, instruments, methods and products that can advance research and industry.

Numerous other embodiments not described in detail here can employ the principles described to particular applications and are within the scope of the claims.

What is claimed is:

1. An apparatus for deposit of fluid samples in an array of mutually isolated dots, comprising a deposit device, a fluid source for repeatedly providing a discrete drop of fluid on the deposit device, mechanism for moving the device relatively over an array of spaced apart deposit locations of a receiving substrate, mechanism for repeatedly moving the device, relatively, toward and away from the receiving substrate to deposit respective drops of fluid at respective deposit locations on the substrate by direct contact of drops of fluid on the deposit device with the substrate without direct contact of the deposit device with the substrate.

2. The apparatus of claim 1 in which the deposit device is flexibly mounted and associated with a dampener that enables compliant, dampened contact of the device with the substrate via an intervening film of the fluid.

3. The apparatus of claim 1 or 2 wherein the deposit device is a moveable pin.

4. The apparatus of claim 1 wherein the fluid source includes a fluid storage device relative to which the deposit device repeatedly moves to resupply the device during the deposit of successive drops.

5. The apparatus of claim 4 in which the fluid storage device is a local fluid storage device generally movable over the array of deposit locations, the fluid storage device being constructed and arranged to resupply the deposit device at various locations with respect to the array.

6. The apparatus of claim 5 in which the local fluid storage device and the deposit device are coupled for transverse motion across the array.

7. The apparatus of claim 6 in which the local fluid storage device and the deposit device are decoupled for movement toward and away from the substrate.

8. The apparatus of claim 5 in which the local storage device is constructed and arranged to be replenished from a remotely located relatively large reservoir.

9. The apparatus of claim 8 in which the reservoir is constructed to store a multiplicity of isolated fluid volumes, the apparatus constructed to move the local supply device to a selected fluid volume of said reservoir for replenishment.

10. The apparatus of claim 9 in which the volumes comprise the wells of a plate and the local storage device is constructed to dip into the well.

11. The apparatus of claim 10 in which the local storage device has a fluid retaining surface having a surface roughness of at least 1000 microinch.

12. The apparatus of claim 5 constructed to produce relative resupply movement between the deposit device and the local storage device for the deposit of each discrete fluid drop.

13. The apparatus of claim 5 in which the deposit device is a moveable pin and the local storage device includes a member which defines a generally annular fluid retention surface, and the deposit pin is constructed to move within the annular retention surface from retracted to extended positions, in the retracted position the deposit end of the pin being retracted from the lower surface of fluid retained by the annular surface of the storage device, and in the extended position the deposit end of the pin being projected beyond the lower surface of the retained fluid.

14. The apparatus of claim 13 in which the annular surface is generally aligned with the pin and a driver is associated with the member that defines the annular surface to move the member generally linearly downwardly beyond a position of a deposit end of the pin to a replenishment position, the pin and the member defining the annular surface and associated drivers being movable to the cleaning system, and to a replenishment region in which the annular member is replenished.

15. The apparatus of claim 1 in which the deposit device is mounted on a flexure which constrains the device to a predetermined path of travel, and a driver is engaged to cause reciprocal motion constrained by the flexure, between retracted and extended positions depending upon the position of the driver.

16. The apparatus of claim 1 in which a stable spring is arranged to urge the deposit device in the direction opposite to the deposit motion.

17. The apparatus of claim 1 in which the deposit device is constrained in its path of motion by at least one planar flexure.

18. The apparatus of claim 1 in which the deposit device is mounted on a pair of parallel flexures that maintain the deposit device at a constant angle to a surface on which the drops are deposited.

19. The apparatus of claim 18 in which the parallel flexures are cantivlered and the deposit device is on the free end of the assembly.

20. The apparatus of claim 19 in which at least one of the flexures includes a metal spring element.

21. The apparatus of claim 19 in which at least one of the flexures includes a damping element.

22. The apparatus of claim 21 in which the damping element is a damping layer laminated to a spring layer.

23. The apparatus of claim 22 comprising a lamination of a metal spring layer and a damping layer.

24. The apparatus of claim 22 in which the flexure includes a spring layer laminated on opposite sides of a damping layer.

25. The apparatus of claim 1 in which the deposit device is mounted on a multiple flexure system.

26. The apparatus of claim 25 in which at least one relatively stiff flexure supports the deposit device via at least one intermediate relatively compliant flexure, a driver engaged, effectively, with the relatively stiff flexure, and the deposit device being free to deflect by action of the compliant flexure, upon encountering resistance when moving toward the substrate.

27. The apparatus of claim 1 in which the deposit device is arranged to engage the substrate via a film of the fluid with a pressure less than about 1 gram.

28. The apparatus of claim 1 in which the deposit device has a natural frequency of at least 10 Hz.

29. The apparatus of claim 1 including a cleaning system, and a control system adapted to control relative movement of the deposit device to a depositing relationship to the substrate and a cleaning relationship to the cleaning system.

30. The apparatus of claim 29 in which the deposit device is associated with a local supply device that travels with it, the deposit device and local supply device movable together to the cleaning system.

31. An apparatus for deposit of fluid samples in a dense array of mutually isolated dots, comprising a deposit device, a fluid source for repeatedly providing fluid to the deposit device, mechanism for moving the device relatively over an array of spaced apart deposit locations of a receiving substrate, mechanism for repeatedly moving the deposit device, relatively, toward and away from the receiving substrate to deposit respective drops of fluid at respective deposit locations on the substrate, and a control system adapted to control relative movement of the deposit device to a deposit relationship with the substrate, wherein the deposit device is mounted on a flexure system which constrains the device to precise motion, and a driver is engaged to drive the deposit device to enable reciprocal motion, constrained by the flexure system, between retracted and extended positions depending upon the position of the driver.

32. The apparatus of claim 31 in which the flexure system is constructed to maintain substantially a constant angle between the deposit device and the substrate as the deposit device approaches the substrate.

33. The apparatus of claim 32 in which the flexure system comprises a pair of parallel flexures.

34. The apparatus of claim 33 in which the flexures are ______.

35. The apparatus of claim 32 in which the flexure system comprises a single flexure.

36. The apparatus of claim ______ in which the deposit device is mounted on a multiple flexure system.

37. The apparatus of claim 35 in which a relatively stiff flexure supports the deposit device via an intermediate relatively compliant flexure, the driver for the device engaged, effectively, with the relatively stiff flexure, and the deposit device being free to deflect relative to the stiff flexure by action of the compliant flexure, upon encountering resistance when moving toward the substrate.

38. An apparatus for deposit of fluid samples in a dense array of mutually isolated dots, comprising a deposit pin, a fluid source for repeatedly providing a drop of fluid on the end of the deposit pin, mechanism for moving the pin relatively over an array of spaced apart deposit locations of a receiving substrate, mechanism for repeatedly moving the pin, relatively, toward and away from the receiving substrate to deposit respective drops at respective deposit locations on the substrate, and wherein the pin is mounted on a flexure system which constrains the pin to a predetermined path of travel, and a driver is engaged to drive the pin to enable reciprocal motion, constrained by the flexure system, between retracted and extended positions depending upon the position of the driver.

36. An apparatus for deposit of fluid samples in a dense array of mutually isolated dots, comprising at least two deposit pins, at least one fluid source for repeatedly providing a drop of fluid on the end of each deposit pin, mechanism for moving the pins together transversely over an array of spaced apart deposit locations of a receiving substrate, mechanism for repeatedly moving each pin independently, relatively, toward and away from the receiving substrate to deposit respective drops at respective deposit locations on the substrate.

37. The apparatus of claim 36 constructed to mount a number of microscope slides to serve as said substrate in deposit-receiving relationship, and a control system constructed and arranged to move the deposit pins in the manner to form deposits on more than one slide.

36. The apparatus of claim 22 in which at least four such pins and drivers are mounted on a deposit head.

37. A deposit mechanism for deposit of biological fluid dots in an array, comprising a pin supported by a flexure, a source of biological fluid for deposit, and a driver engaged to drive the pin to enable reciprocal motion constrained, between retracted and extended positions depending upon the position of the driver.

38. The apparatus of claim 37 including a discrete local fluid supply for the pin.

39. The apparatus of claim 38 in which a member defines a generally annular fluid retention surface, and the deposit pin is constructed to move within the annular retention surface from retracted to extended positions, in the retracted position the deposit end of the pin being retracted from the lower surface of fluid retained by the annular surface of the storage device, and in the extended position the deposit end of the pin being projected beyond the lower surface of the retained fluid.

40. The apparatus of claim 39 in which a driver is arranged to move the annular member generally downwardly beyond the deposit end of the pin to a replenishment position.

41. The apparatus of claim 40 in which the flexure-mounted pin and the member defining on annular retention surface are associated with respective drivers.

42. The apparatus of claim 40 in which the pin and member are movable as an assembly to a station for cleaning, and to a replenishment region in which the member is replenished from a selected source.

43. The apparatus in which at least four pin and annular member assemblies according to claim 40 are clustered for movement together transversely over the substrate.

43. The apparatus in which two or more deposit pins according to claim 39 are grouped together for movement by a single drive as a corresponding member of members defining annular fluid retention surfaces according to claim 39 are associated respectively with respective pins, the members driven by a single drive member.

44. An apparatus for deposit of fluid samples in a dense array of mutually isolated dots, comprising a deposit device, a source of fluid for the deposit device, mechanism for moving the deposit device relatively over an array of spaced apart deposit locations of a receiving substrate, mechanism for repeatedly moving the deposit device, relatively toward and away from the receiving substrate to deposit respective drops of fluid at respective deposit locations on the substrate, a cleaning system, and a control system adapted to control relative movement of the deposit device between a resupply relationship to the source, a depositing relationship to the substrate and a cleaning relationship to the cleaning system.

45. The apparatus of claim 44 wherein the source includes a fluid storage device relative to which the deposit device repeatedly moves to resupply the device during the deposit of the isolated drops of fluid.

46. The apparatus of claim 45 in which the fluid storage device is a mobile local fluid storage device generally movable with the deposit device over the array of deposit locations, the fluid storage device being constructed and arranged to locally resupply the deposit device during its deposit sequence.

47. The apparatus of claim 46 in which the local storage device is constructed and arranged to be replenished from a remotely located relatively large reservoir.

48. The apparatus of claim 47 in which the reservoir is constructed to store a multiplicity of isolated fluid volumes, the apparatus constructed to move the local supply device to a selected fluid volume of said reservoir for replenishment.

49. The apparatus of claim 47 constructed to produce relative resupply movement between the deposit device and the local storage device for the deposit of each discrete drop.

40. The apparatus of claim 46 in which the local supply device is driven to enter a supply well and having a surface adapted to retain a supply of fluid by surface tension or capillar effects.

41. The apparatus of claim 40 in which a retaining surface of the local supply has surface roughness of at least 1000 microinch.

42. The apparatus of claim 41 in which a member has an inner annular surface having the surface roughness.

43. The apparatus of claim 44 in which the member has an outer surface that is by ______.

44. The apparatus of claim 41 sized and constructed to enter a well of a PCR plate and extract fluid by surface position or capillary efforts for supply to the deposit device.

45. Apparatus for automated preparation of a microscope slide, comprising a microscope slide holder, a carrier operative over a slide on the holder, and a deposition head mounted on the carrier, the deposition head including a deposit pin constructed to carry a drop of fluid from a fluid supply, and mechanism constructed, in a deposit sequence, to move the deposit pin relative to the supply to pick up a drop of fluid, and move the deposit pin toward the microscope slide to completely deposit the drop of fluid on the slide, there being a control system arranged to repeat the deposit sequence to produce a high density of drops of deposited fluid upon the slide.

46. The device of claim 45 in which the deposit pin has a deposit end comprising an abrupt profile that defines the perimeter of the drop of fluid to be picked up.

47. The device of claim 46 in which the pin comprises a generally cylindrical shaft and an end rim.

48. The deposition head of claim 47 in which the end rim is defined by a generally planar butt end of the pin.

49. The device of claim 45 wherein the supply comprises a sub-reservoir mounted on the head, closely adjacent to the deposit pin.

50. The device of claim 45 or 49 constructed to prepare a series of slides in identical manner, the carrier constructed to hold a series of slides, and the control system constructed to deposit a drop of a given composition upon identical locations on the series of slides, by respective movements of the head.

51. The device of claim 50 in which the deposition head comprises a multiplicity of said deposit pins ganged to form a multiplicity of drops.

52. The device of claim 50 in which the deposit pins are associated with respective discrete drivers.

53. The device of claim 51 in which the deposit pins are associated with a single driver.

54. The device of claim 45 wherein the deposition head comprises an annular supply ring constructed to be immersed in and withdrawn from a well of a sample-containing reservoir to retain between wall portions of the annular ring a supply of fluid carrying material to be examined, the deposit pin being operative within the annular ring to move generally axially between a retracted position in which a deposit end of the pin is withdrawn above an exposed surface of the retained sample, and an extended position in which a dot of the fluid is carried on the end of the pin for deposit on the slide.

55. The device of claim 45 or 54 in which the deposit pin is mounted on at least one flexure that constrains the deposit pin to a predetermined path of travel relative to the head.

56. Apparatus for deposit of fluid samples in a dense array of mutually isolated dots on a receiving surface comprising a deposit pin, a fluid source for repeatedly providing a drop of fluid on the end of the deposit pin, mechanism for moving the pin relatively over an array of spaced apart deposit locations of a receiving substrate, mechanism for repeatedly moving the pin, relatively, toward and away from a targeted point on the receiving substrate to deposit respective drops of fluid at respective deposit locations on the receiving surface, and means for stopping movement of the depositing pin toward the targeted point on the receiving surface while fluid remains between the end of the pin and the receiving surface.

57. The apparatus of claim 56 in which said means comprises a compliant system that limits the motion of the pin in response to resistance force transmitted to the pin.

58. The apparatus of claim 57 in which the resistance force is predetermined to be less than the total displacing force required to cause the pin to displace the fluid so much that the pin makes solid contact with the receiving surface.

59. The apparatus of claim 56 in which a spring system mounting the deposit pin limits the force with which the deposit pin presses toward the receiving surface.

60. The apparatus of claim 59 in which the deposit pin is coupled to the driver by a weak spring of selected spring value.

61. The apparatus of claim 60 in which the strength of the spring is selected to enable the deposit pin to cease movement toward the receiving surface before termination of movement of the driver.

62. The apparatus of claim 54 or 45 in which over-travel of the driver of the pin toward the receiving surface is permitted by the weak spring without significant effect upon the spacing of the end of the pin from the receiving surface.

63. The apparatus of claim 57 in which the compliant system including a leaf spring or flexure.

64. The apparatus of claim 60 in which the weak spring is supported on a relatively stiff spring engaged by the driver for moving the deposit pin.

65. An apparatus comprising a deposit pin constructed and arranged to deposit a first dot upon a substrate and thereafter, in registration, to deposit a second dot upon the first dot.

66. The apparatus of claim 65 in combination with a source of multiple fluids comprising a first fluid for said first dot and a second fluid for the second dot, the first and second fluids selected to potentially interact.

67. The apparatus of claim 65 including a device for depositing a large spot of a given reagent and a device for depositing dots of smaller size of different reagents upon the deposited large dot.

68. A fluid deposit arranger for transferring a drop of fluid to a substrate by engaging the drop with the substrate, the device mounted on a compliant spring for compliant engagement with the substrate and incorporating a motion damping member.

69. The fluid deposit arranger of claim 68 in which the spring comprises a flexure mounting.

70. The arranger of claim 69 in which at least one portion of the flexure mounting comprises a composite in which a layer of flexible damping material is bonded to a flexure member.

71. The arranger of claim 70 in which a pair of flexure members are bonded together in a composite sandwich containing a layer of damping material.

72. The arranger of claim 70 in which the flexible damping layer comprises a rubber or rubber-like compound.

73. The arrayer according to claim 71 in which at least one of the flexure layers of the composite is a resilient plastic layer.

74. The arrayer according to claim 73 in which at least one of the flexure layers comprise polyamide.

75. The arrayer according to claim 71 in which one of the flexure layers comprises a spring metal and the other layer comprises a bonding material having damping characteristics.

76. The arrayer according claim 69 in which the flexure is a planar flexure about 8 mm in width and between about 20 and 25 mm in length.

77. The arrayer according to claim 71 in which a layer of flexible resin is laminated by rubber cement to a flexible metal layer.

78. The arrayer of claim 68 in which a deposit pin is mounted upon a pair of parallel flexures.

79. The array of claim 78 in which at least one of the flexures comprises spring metal, and the other comprises, at least in part, a material having greater dampening properties than said spring metal.

80. The arrayer of claim 78 in which both parallel flexures comprise a sandwich according to claim 77.

81. The arrayer of claim 68 having a natural frequency greater than about 10 HZ.

82. A deposit head including at least two flexure mounted pins, and a single actuator arranged to move the pins simultaneously from supply to deposit positions, the head mounted for lateral movement in both X and Y axes.

83. The deposit head of 82 in which the pins are spaced apart 9 mm.

84. A deposit head including at least two flexure mounted pins, each associated with its own actuator to be moved independently from supply to deposit position, the head mounted for lateral movement in both X and Y axes.

85. The deposit head of claim 84 in which the pins are spaced apart 9 mm.

86. An aliquot carrier defining a fluid-retaining aperture through which a deposit device can transit to pick up a drop of fluid to be deposited, internal surfaces defining said aperture having a surface roughness that increases its wettability.

87. The carrier of claim 86 in which the surface roughness is produced by a technique selected from the class of sanding, broaching, machining, screw or knurl forming, coating or forming the surface of particles that provide surface roughness as by sintering or molding.

87. The carrier of claim 86 in which the surface roughness is at least 100 microinch.

88. A process of printing comprising, under computer control, moving at least one flexure mounted pin to selected X,Y positions, and depositing with said pin, a desired material.

89. The method of claim 88 in which the material is an ink or dye.

90. The method of claim 89 in which the material is a photoresist material.

91. The method of claim 88 in which the material is a varnish or encapsulant.

92. A method of causing a biological compound to interact with another substance at a predetermined position on a substrate the step comprising depositing at least one of the compound or reagent in a precisely determined localized spot relative to the substrate by mechanically lowering a compliant pin, to which a drop of the compound or reagent is adhered by surface tension, toward the substrate until the drop contacts the substrate or a pre-applied compound on the substrate with the pin executing a controlled force of less than a gram thereon, and thereafter mechanically lifting the pin away from the substrate under conditions in which the fluid drop transfers to the substrate or the pre-applied compound on the substrate.

93. The method of claim 92 in which drops of both the compound and the other substance are successively deposited by the technique of claim 92.

94. The method of claim 92 in which the pin, when approaching the substrate, applies a force to the substrate with a force of abouth 0.5 grams.

95. The method of claim 92 in which the compliant pin is mounted upon a support by flexures that constrain the pin to substantially linear motion relative to the support, and moving the support carrying the flexures and pin toward the substrate in an overtraveling linear motion parallel to the direction to which the pin is constrained to deflect, during which motion the pin engages the substrate or pre-applied compound on the substrate, and the flexures deflect in response to resistance encountered by the pin, thereby cushioning the contact of the pin.

96. The method of claim 92 in which a supply of the biological compound or substance to be deposited by the pin is supported above the substrate at the deposit location within a ring by surface tension, and the pin is lowered through the ring in the manner that a relatively small drop of the reagent from the supply is adhered to the end of the pin by surface tension.

97. The method of claim 92 in which the fluid to be deposited from fluid selected the group of fluids described in the specification.

98. The method of depositing a biological fluid with a pin comprising supporting fluid within a ring by surface tension, and the pin is lowered through the ring in the manner that a relatively small drop of the reagent from the supply is adhered to the end of the pin by surface tension.
